(19) United States
(12) Patent Application Publication
(10) Pub. No.: US 2022/0414553 A1
(43) Pub. Date: Dec. 29, 2022

(54) INFORMATION PROCESSING DEVICE, INFORMATION PROCESSING METHOD AND NON-TRANSITORY COMPUTER READABLE MEDIUM

(71) Applicant: Kioxia Corporation, Tokyo (JP)

(72) Inventors: Hideki YAMADA, Yokohama (JP); Masanobu SHIRAKAWA, Chigasaki (JP); Marie KURONAGA, Yokohama (JP); Hideki KAWASAKI, Yokohama (JP)

(73) Assignee: Kioxia Corporation, Tokyo (JP)

(21) Appl. No.: 17/903,333

(22) Filed: Sep. 6, 2022

Related U.S. Application Data
(63) Continuation of application No. PCT/JP2020/009704, filed on Mar. 6, 2020.

(51) Int. Cl. G06Q 10/02

(52) U.S. Cl. CPC G06Q 10/02; G06Q 2240/00

(57) ABSTRACT

An information processing device to reserve a parking lot for a vehicle includes a reception unit; a first retrieval unit; a second retrieval unit; and a reservation unit. The reception unit receives first information regarding a destination of the vehicle. The first retrieval unit retrieves a route to the destination based on the first information. The second retrieval unit retrieves a route to the destination, a first area around the route, and first time. The reservation unit requests a reservation for a first parking lot in the first area at the first time using wireless or wired communication without waiting for an instruction from a user.

### CROSS-REFERENCE TO RELATED APPLICATIONS

This application is a Continuation application of PCT Application No. PCT/JP2020/009704, Mar. 6, 2020, the entire contents of which are incorporated herein by reference.

### FIELD

Embodiments described herein relate generally to an information processing device, an information processing method and a non-transitory computer readable medium.

### BACKGROUND

Carsharing services have become widespread in recent years. An information processing device, an information processing method and an information processing program, which enable a user to use a parking lot with efficiency, are provided.

### BRIEF DESCRIPTION OF THE DRAWINGS

FIG. 1 is a conceptual diagram of a parking lot reservation system according to a first embodiment.

FIG. 2 is a block diagram of an electric vehicle according to the first embodiment.

FIG. 3 is a block diagram of a smartphone held by a user who uses a carsharing service according to the first embodiment.

FIG. 4A is a block diagram of a server of a carsharing company according to the first embodiment.

FIG. 4B is a conceptual diagram of a vehicle information database according to the first embodiment.

FIG. 4C is a functional block diagram of a processor in the server of the carsharing company according to the first embodiment.

FIG. 5A is a block diagram of a server of a parking lot scheduling company according to the first embodiment.

FIG. 5B is a conceptual diagram of parking lot contract information according to the first embodiment.

FIG. 5C is a conceptual diagram of a reservation timetable according to the first embodiment.

FIG. 5D is a functional block diagram of a processor in the server of the parking lot scheduling company according to the first embodiment.

FIG. 6 is a flowchart showing a route retrieval method according to the first embodiment.

FIG. 7 is a block diagram of a server of a parking lot scheduling company according to a second embodiment.

FIG. 8A is a conceptual diagram of rate information according to the second embodiment.

FIG. 8B is a conceptual diagram of the rate information according to the second embodiment.

FIG. 8C is a conceptual diagram of the rate information according to the second embodiment.

FIG. 8D is a conceptual diagram of the rate information according to the second embodiment.

FIG. 9 is a functional block diagram of a processor in the server of the parking lot scheduling company according to the second embodiment.

FIG. 10 is a flowchart showing a route retrieval method according to the second embodiment.

FIG. 11A is a block diagram of a server of a carsharing company according to a third embodiment.

FIG. 11B is a conceptual diagram of accommodation evaluation information according to the third embodiment.

FIG. 11C is a conceptual diagram of movement income information according to the third embodiment.

FIG. 11D is a conceptual diagram of size information according to the third embodiment.

FIG. 11E is a conceptual diagram of priority information according to the third embodiment.

FIG. 11F is a functional block diagram of a processor in a server of the carsharing company according to the third embodiment.

FIG. 12A is a block diagram of a server of a parking lot scheduling company according to the third embodiment.

FIG. 12B is a conceptual diagram of parking lot contract information according to the third embodiment.

FIG. 13 is a flowchart showing a route retrieval method according to the third embodiment.

FIG. 14 is a conceptual diagram of route information according to a fourth embodiment.

FIG. 15 is a flowchart showing a route retrieval method according to the fourth embodiment.

FIG. 16A is a conceptual diagram of information obtained from parking lot contract information according to the fourth embodiment.

FIG. 16B is a conceptual diagram of information obtained from a reservation timetable according to the fourth embodiment.

FIG. 16C is a conceptual diagram of the reservation timetable according to the fourth embodiment.

FIG. 17 is a flowchart showing a parking lot determination method according to a modification to the fourth embodiment.

FIG. 18 is a conceptual diagram of a parking lot reservation system according to a fifth embodiment.

FIG. 19 is a flowchart showing a route retrieval method according to the fifth embodiment.

FIG. 20A is a conceptual diagram of information obtained from parking lot contract information according to the fifth embodiment.

FIG. 20B is a conceptual diagram of information obtained from a reservation timetable according to the fifth embodiment.

FIG. 20C is a conceptual diagram of the reservation timetable according to the fifth embodiment.

FIG. 21 is a block diagram of a smartphone held by a user who registers a parking lot in a parking lot reservation system according to a sixth embodiment.

FIG. 22A is a flowchart showing a route retrieval method according to the sixth embodiment.

FIG. 22B is a conceptual diagram of a reservation timetable according to the sixth embodiment.

FIG. 22C is a conceptual diagram of a reservation timetable according to the sixth embodiment.

FIG. 22D is a schematic diagram showing a display screen of a smartphone of a parking lot owner according to the sixth embodiment.

FIG. 22E is a schematic diagram showing a display screen of the smartphone of the parking lot owner according to the sixth embodiment.

FIG. 22F is a schematic diagram showing a display screen of the smartphone of the parking lot owner according to the sixth embodiment.

FIG. 22G is a schematic diagram showing a display screen of the smartphone of the parking lot owner according to the sixth embodiment.

FIG. 22H is a schematic diagram showing a display screen of the smartphone of the parking lot owner according to the sixth embodiment.

FIG. 22I is a schematic diagram showing a display screen of the smartphone of the parking lot owner according to the sixth embodiment.

FIG. 23 is a flowchart showing a parking lot reservation method according to a seventh embodiment.

FIG. 24 is a conceptual diagram of evaluation information according to an eighth embodiment.

FIG. 25A is a functional block diagram of a processor in an electric vehicle according to the eighth embodiment.

FIG. 25B is a flowchart showing a parking evaluation method according to the eighth embodiment.

FIG. 25C is a flowchart showing a parking lot evaluation method according to the eighth embodiment.

FIG. 25D is an external view of the electric vehicle according to the eighth embodiment.

FIG. 25E is an external view of the electric vehicle according to the eighth embodiment.

FIG. 25F is a block diagram of the electric vehicle according to the eighth embodiment.

FIG. 25G is a flowchart showing a parking lot evaluation method according to the eighth embodiment.

FIG. 26 is a conceptual diagram of route information according to a ninth embodiment.

FIG. 27A is a conceptual diagram of a reservation timetable according to the ninth embodiment.

FIG. 27B is a conceptual diagram of a reservation timetable according to the ninth embodiment.

FIG. 28A is a conceptual diagram of parking lot contract information according to the ninth embodiment.

FIG. 28B is a conceptual diagram of a scenario weight table according to the ninth embodiment.

FIG. 29A is a conceptual diagram of rate information according to the ninth embodiment.

FIG. 29B is a conceptual diagram of rate information according to the ninth embodiment.

FIG. 29C is a conceptual diagram of rate information according to the ninth embodiment.

FIG. 29D is a conceptual diagram of rate information according to the ninth embodiment.

FIG. 30A is a conceptual diagram of parking lot contract information according to the ninth embodiment.

FIG. 30B is a conceptual diagram of a scenario weight table according to the ninth embodiment.

FIG. 31 is an equation for calculating an average parking fee according to the ninth embodiment.

FIG. 32A is a conceptual diagram of parking lot contract information according to the ninth embodiment.

FIG. 32B is a conceptual diagram of a scenario weight table according to the ninth embodiment.

FIG. 33 is a block diagram of a server of a parking lot scheduling company according to a tenth embodiment.

FIG. 34A is a conceptual diagram of parking lot contract information according to an eleventh embodiment.

FIG. 34B is a conceptual diagram of a vehicle information database according to the eleventh embodiment.

FIG. 34C is a flowchart showing a route retrieval method according to the eleventh embodiment.

FIG. 35A is a conceptual diagram of a reservation timetable according to a twelfth embodiment.

FIG. 35B is a conceptual diagram of a reservation timetable according to the twelfth embodiment.

### DETAILED DESCRIPTION

In general, according to one embodiment, an information processing device to reserve a parking lot for a vehicle includes a reception unit; a first retrieval unit; a second retrieval unit; and a reservation unit.

The reception unit receives first information regarding a destination of the vehicle. The first retrieval unit retrieves a route to the destination based on the first information. The second retrieval unit retrieves a route to the destination, a first area around the route, and first time. The reservation unit requests a reservation for a first parking lot in the first area at the first time using wireless or wired communication without waiting for an instruction from a user.

Embodiments will be described below with reference to the drawings. In the following description, components having the same function and configuration will be denoted by a common reference sign.

### 1. FIRST EMBODIMENT

An information processing device, an information processing method and an information processing program according to a first embodiment will be described. The first embodiment relates to a parking lot (space) reservation system for electric vehicles and, as an example, to a level 4 or level 5 automated-driving (self-driving) or driverless vehicle, and a parking lot operating method for such a vehicle.

### 1.1 Configuration

### 1.1.1 Overall Configuration

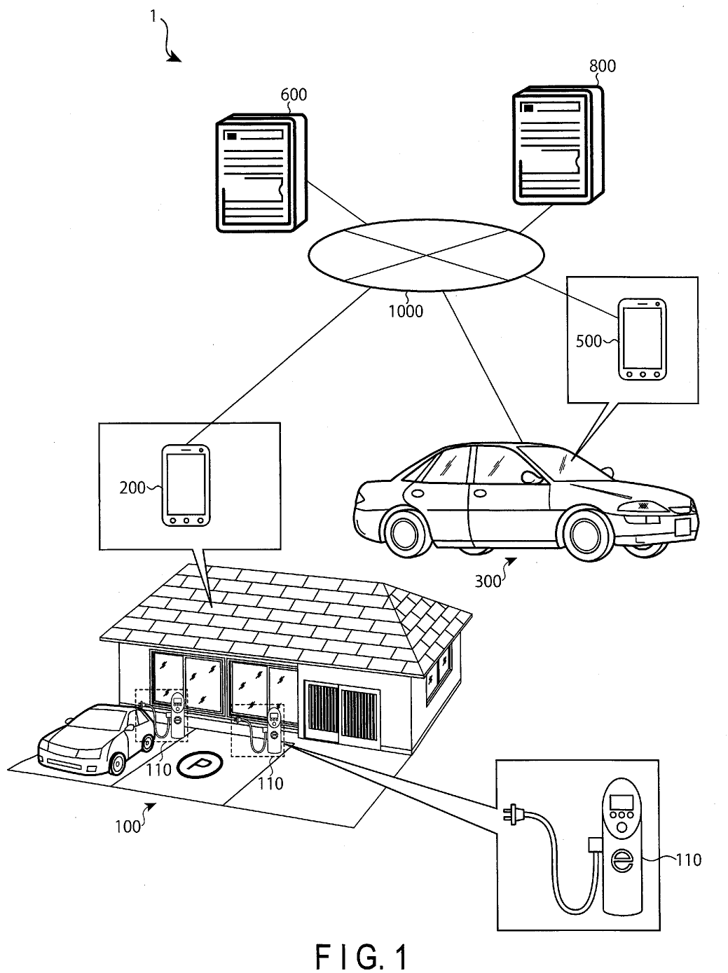

FIG. 1 shows a configuration example of a parking lot reservation system according to the first embodiment.

As shown in FIG. 1, a reservation system 1 includes a parking lot 100, handheld terminals 200 and 500, an electric vehicle (car) 300 and servers 600 and 800. In the following example, the handheld terminals 200 and 500 are smartphones, but they may be portable information communication terminals such as a mobile phone, a tablet personal computer (PC) and a notebook PC. Alternatively, the handheld terminal 200 may be a desktop PC, and the handheld terminal 500 may be a car navigation system installed in the electric vehicle. Neither of the handheld terminals 200 and 500 is limited to a handheld type.

The smartphones 200 and 500 can communicate with the servers 600 and 800 via the network 1000 by wireless communication, for example. The electric vehicle 300 also has a wireless communication function and can communicate with the servers 600 and 800 via the network 600.

In response to′ requests from the electric vehicle 300 and the smartphones 200 and 500, the servers 600 and 800 perform a variety of computations and provide various information items to the electric vehicle 300 and the smartphones 200 and 500.

In the foregoing reservation system 1, the parking lot 100 is individual or corporate land and is leased to a third party according to the conditions set by the owner. In the parking lot 100, a charger 110 for charging the battery of the electric vehicle 300 is installed. The smartphone 200 is held by the owner of the parking lot 100. The smartphone 200 receives information from the owner of the parking lot 100 and transmits the received information to the server 800. Then, the smartphone 200 displays the information received from the server 800 on its display and presents it to the owner of the parking lot 100.

Upon receiving information of a travel route to a destination, and the like from the server 600, for example, the vehicle 300 travels to the destination by automated driving. The smartphone 500 is held by a customer (user) of the vehicle 300. Then, the smartphone 500 receives information from the user and transmits the received information to the server 600. The smartphone 500 also displays the information received from the server 600 on its display and presents it to the user.

The server 600 is managed by an operator who manages the vehicle 300. The vehicle 300 according to the first embodiment is not owned by individuals. That is, a plurality of vehicles 300 are owned by an operator (hereinafter referred to as a carsharing company) who manages the vehicles 300, and are shared among a number of users. The server 600 determines a travel route and the like according to the information received from the user's smartphone 500, and instructs the vehicle 300 to travel according to the determined route.

The server 800 is managed by an operator who manages the parking lot 100. The parking lot 100 according to the first embodiment may be, for example, a parking lot for a private house or a corporate-owned building, or may be a parking lot that has been used for parking business. That is, the operator who manages the server 800 (hereinafter referred to as a parking lot scheduling company) makes contracts with a plurality of parking owners to manage the parking lot 100. The parking owners receives a reservation for a necessary parking lot 100 according to a request from the carsharing company.

Below is a description of configurations of the electric vehicle 300, smartphone 500 and servers 600 and 800.

1.1.2 Configuration of Electric Vehicle 300

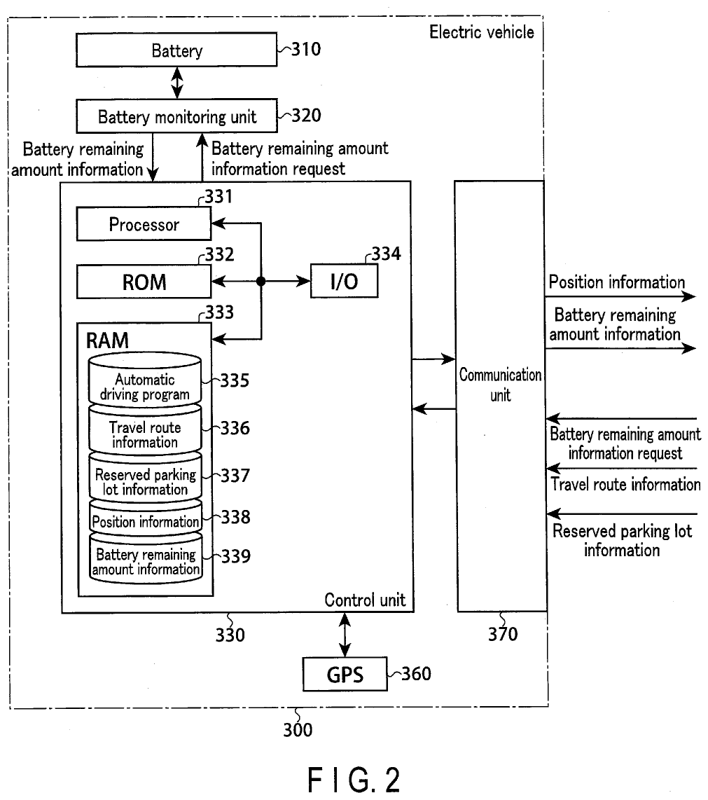

First, the configuration of the electric vehicle 300 will be described with reference to FIG. 2. FIG. 2 is a block diagram showing a configuration example of part of the electric vehicle 300, which particularly relates to a parking lot reservation system.

As shown in FIG. 2, the electric vehicle 300 includes a battery 310, a battery monitoring unit 320, a control unit 330, a global positioning system (GPS) receiver 360 and a communication unit 370.

The battery 310 is used to drive the electric vehicle 300.

The battery monitoring unit 320 monitors the remaining amount of the battery 310. The battery remaining amount may be monitored continuously in time or at regular time intervals.

The communication unit 370 is a wireless communication circuit capable of transmitting and receiving information to and from the server 600 via the network 1000 by wireless communication. The communication unit 370 transfers data from the server 600 to the control unit 330, and transmits data from the control unit 330 to the server 600.

The GPS receiver 360 receives a signal from a GPS satellite to ascertain the position of the vehicle 300. Then, the GPS receiver 360 transmits the position information of the vehicle 300 to the control unit 330.

The control unit 330 controls a process for the travel of the vehicle 300. The control unit 330 includes a processor 331, a ROM 332, a RAM 333 and an input/output circuit 334. The ROM 332 and RAM 333 store programs executed by the processor 331 and necessary data. The RAM 333 functions as a work area of the processor 331. The input/output circuit 334 controls transmission and reception of information to and from the communication unit 370. The processor 331 executes programs in the ROM 332 and RAM 333. For example, the RAM 333 stores an automatic driving program 335, travel route information 336, reserved parking lot information 337, position information 338 and battery remaining amount information 339.

The automatic driving program 335 includes contents controlled by the processor 331, which are necessary to enable the vehicle 300 to travel by automated driving. The travel route information 336 includes information on route from the departure place to the destination of the vehicle 300, and is provided from the server 600, for example. The reserved parking lot information 337 includes information on the parking lot 100 reserved in the travel route and is provided from the server 600, for example. Then, the processor 331 executes the program 335 to cause the vehicle 300 to travel according to the information 336 and park itself in the parking lot 100 designated by the information 337. The position information 338 includes information indicating the position of the vehicle 300 and is provided from the GPS receiver 360. The battery remaining amount information 339 includes information indicating the remaining amount of the battery 310 and is provided from the battery monitoring unit 320. The position information 338 and the battery remaining amount information 339 are transmitted to the server 600, for example, by the communication unit 370.

1.1.3 Configuration of Smartphone 500

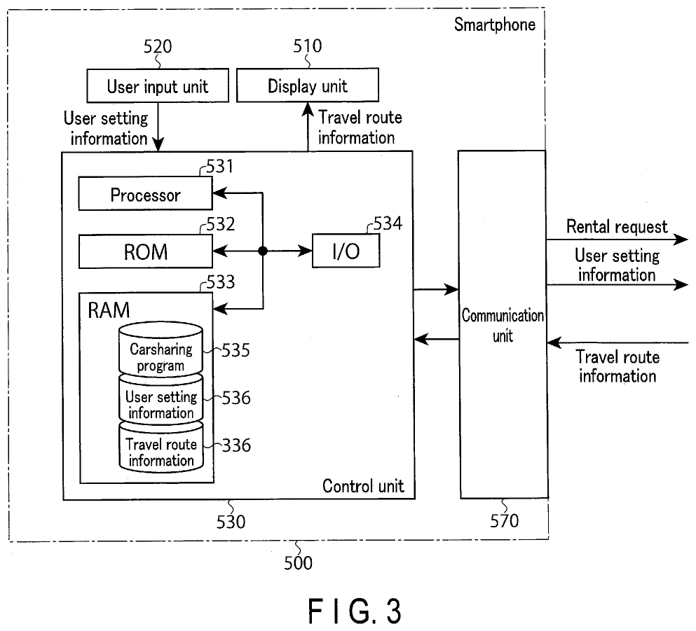

The configuration of the smartphone 500 will be described below with reference to FIG. 3. FIG. 3 is a block diagram showing an example of the configuration of the smartphone 500. As shown in FIG. 3, the smartphone 500 includes a display unit 510, a user input unit 520, a control unit 530 and a communication unit 570.

The display unit 510 presents various information items to a user, and is, for example, a liquid crystal display.

The user input unit 520 receives various information items and instructions (referred to as user setting information) from a user. For example, the display unit 510 may be a touch panel type display device, and the display unit 510 and the user input unit 520 may be integrated as one piece.

The communication unit 570 transmits and receives information to and from the server 600 by wireless communication. For example, the communication unit 570 transmits to the server 600 the user setting information 536 received from the user input unit 520 and a request to rent the vehicle 300 (a request to drive the vehicle 300), and receives the travel route information from the server 600.

The control unit 530 controls the entire process of the smartphone 500. The control unit 530 includes a processor 531 such as a central processing unit (CPU), a read only memory (ROM) 532, a random access memory (RAM) 533 and an input/output circuit 534. The ROM 532 stores programs to be executed by the processor 531 and necessary data. The RAM 533 functions as a work area of the processor 531. The input/output circuit 534 transmits and receives information to and from the communication unit 570. The processor 531 executes programs in the ROM 532 and RAM 533. The RAM 533 stores a carsharing program 535, user setting information 536 and travel route information 336.

The carsharing program 535 causes the smartphone 500 to fulfill various functions including a process necessary to use the vehicle 300. The processor 531 that has executed the program 535 causes, for example, the RAM 533 to store the user setting information 536 received from the user input unit 520. Specific examples of the user setting information 536 include, for example, information regarding the date and time when the electric vehicle 300 is driven, the place of departure, and/or the destination. The travel route information 336 is received from the server 600, for example. Then, the processor 531 causes the display unit 510 to display information on a travel route, destination arrival time based on the travel route, and the like.

1.1.4 Configuration of Server 600

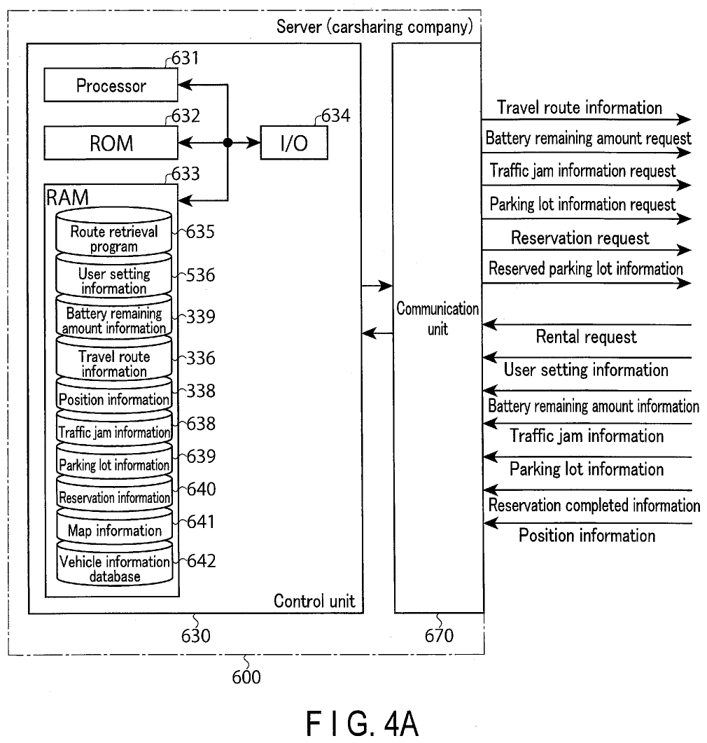

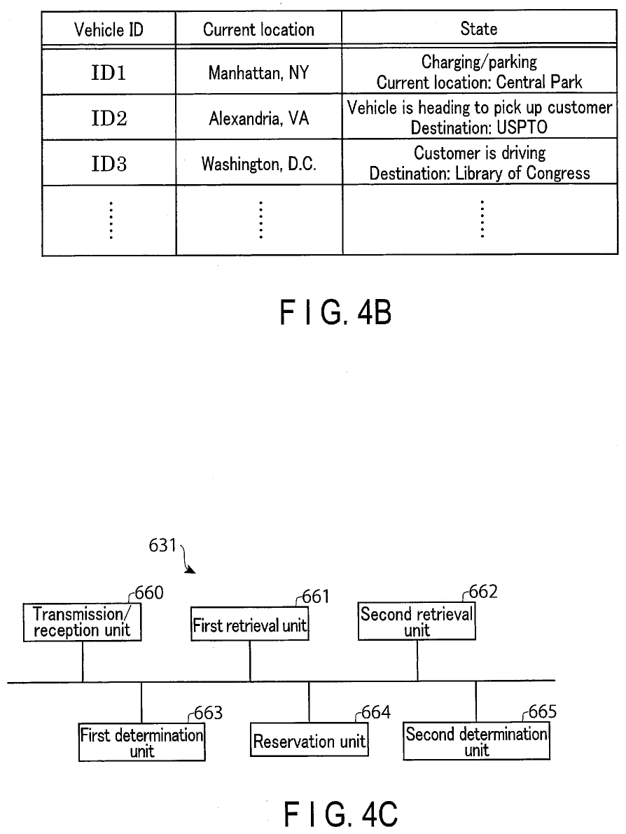

The configuration of the server 600 will be described below with reference to FIG. 4A. FIG. 4A is a block diagram showing an example of the configuration of the server 600. As shown in FIG. 4A, the server 600 includes a control unit 630 and a communication unit 670.

The communication unit 670 transmits and receives information to and from the vehicle 300, smartphones 200 and 500 and server 800 by wireless communication. Note that the communications with the server 800 may be performed by wire and the servers 600 and 800 may be implemented by a single server. The communication unit 670 transmits a request for battery remaining amount information and travel route information to the electric vehicle 300, transmits a request for parking lot information and a reservation request for a parking lot, which will be described later, to the server 800, and transmits a request for traffic jam information to a server not shown. In addition, the communication unit 670 receives battery remaining amount information and position information from the electric vehicle 300, receives a rental request of the vehicle 300 and user setting information 536 from the smartphone 500, receives parking lot information and parking lot reservation information from the server 800, and receives traffic jam information from a server not shown. The traffic jam information may be provided by a handler who deals with road information such as a traffic jam, road construction and accidents.

The control unit 630 includes a processor 631 such as a CPU, a ROM 632, a RAM 633 and an input/output circuit 634. The ROM 632 stores programs executed by the processor 631 and necessary data. The RAM 633 functions as a work area of the processor 631 and stores user setting information 536, battery remaining amount information 339, position information 338, traffic jam information 638, parking lot information 639 and reservation information 640, which are received by the communication unit 670. The RAM 633 also stores a route retrieval program 635, travel route information 336, map information 641 and a vehicle information database 642. The input/output circuit 634 controls transmission and reception of information to and from the communication unit 670. The processor 631 executes the route retrieval program 635 using the information 536, 339, 338, 638, 639, 640 and 641 to calculate a travel route that is considered to be optimal for the user. For example, the processor 631 recognizes a starting point and a destination on the map information 641 to calculate a travel route from the routes connecting the starting point and the destination, on the basis of quick reachability based on the traffic jam information 638, battery charge necessity based on the battery remaining amount information 339, parking lot information 639 and reservation information 640, and user directivity based on the user setting information 536. The travel route information 336 thus calculated is transmitted to the vehicle 300. The travel route information 336 may also be transmitted to the smartphone 500. The user can thus grasp the travel route of the vehicle 300. In addition, the processor 631 issues a reservation request for the parking lot 100 to the server 800 as needed. If the vehicle 300 is an electric vehicle in the present specification, the reservation for the parking lot 100 also means a reservation for charging the battery.

The processor 631 further manages the vehicle 300 owned by the carsharing company using the vehicle information database 642. FIG. 4B is a conceptual diagram of the vehicle information database 642. As shown in FIG. 4B, the database 642 stores information about, for example, the current location and current state of the vehicle 300 owned by the carsharing company. In the example of FIG. 4B, three vehicles 300 are registered in the database 642, and assigned their respective vehicle IDs ID1, ID2 and ID3. In this example, the vehicle 300 of ID1 is currently located in Manhattan, USA and is parked, and its battery is being charged in the parking lot of Central Park. The vehicle 300 of ID2 is currently located in Alexandria in the United States, heading for the U.S. Patent and Trademark Office to pick up the customer. In addition, the vehicle 300 of ID 3 is currently located in Washington, D.C. in the United States, and its customer is driving to the destination, the Library of Congress. The processor 631 updates the database 642 in real time based on the travel route information 336 and the position information 338.

For the sake of simplifying the expressions in the following description, when the vehicles 300 are distinguished by the vehicle ID, a vehicle 300 whose vehicle ID is IDi (i is a natural number) may be referred to as “vehicle IDi.”

FIG. 4C is a functional block diagram of the processor 631 (or the entire control unit 630) while the route retrieval program 635 is being executed. As shown in FIG. 4C, the processor 631 executes the program 635 to function as a transmission/reception unit 660, a first retrieval unit 661, a second retrieval unit 662, a first determination unit 663, a reservation unit 664 and a second determination unit 665.

The transmission/reception unit 660 receives the battery remaining amount information 339 from the electric vehicle 300 via the communication unit 670, receives information regarding a destination (user setting information 536) from the smartphone 500, and further receives information regarding a route to the destination (traffic jam information 638). The transmission/reception unit 660 also receives the parking lot information 639 and the reservation information 640 from the server 800. The transmission/reception unit 660 transmits a reservation request to the server 800 and transmits the travel route information 336 to the vehicle 300.

The first retrieval unit 661 retrieves a travel route to a destination based on at least the user setting information 536 and the traffic jam information 638. When a reservation for a parking lot is required, the second retrieval unit 662 retrieves an area of the parking lot to be reserved, time when the parking lot is to be reserved, and the like, based on the travel route retrieved by the first retrieval unit 661.

The first determination unit 663 determines whether the battery 310 needs to be charged before the vehicle reaches the destination on the basis of the battery remaining amount information 339 and the travel route retrieved by the first retrieval unit 661. When the first determination unit 663 determines that the battery 310 needs to be charged, the reservation unit 664 issues a reservation request for the parking lot 100 based on the area and/or time retrieved by the second retrieval unit 662, and transmits the reservation request to the server 800. The reservation request is issued without waiting for an instruction from the user, i.e., the customer of the vehicle 300.

The second determination unit 665 determines the final travel route of the vehicle 300 based on the travel route retrieved by the first determination unit 663, the determination result made by the first determination unit 663, and the position of the parking lot 100 reserved in response to the reservation request issued by the reservation unit 664.

1.1.5 Configuration of Server 800

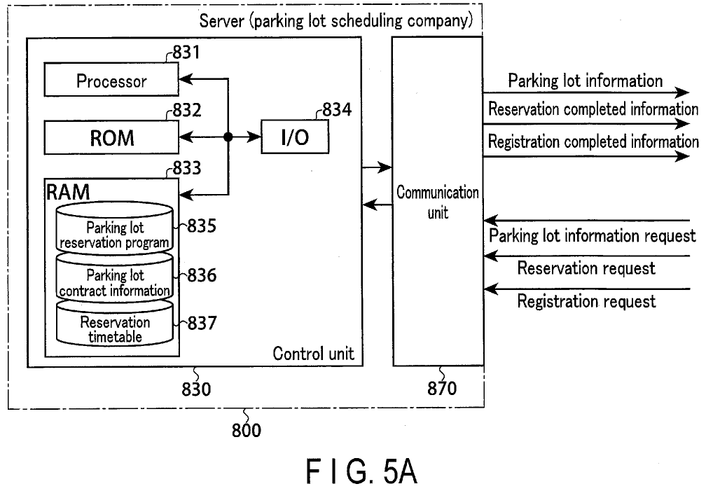

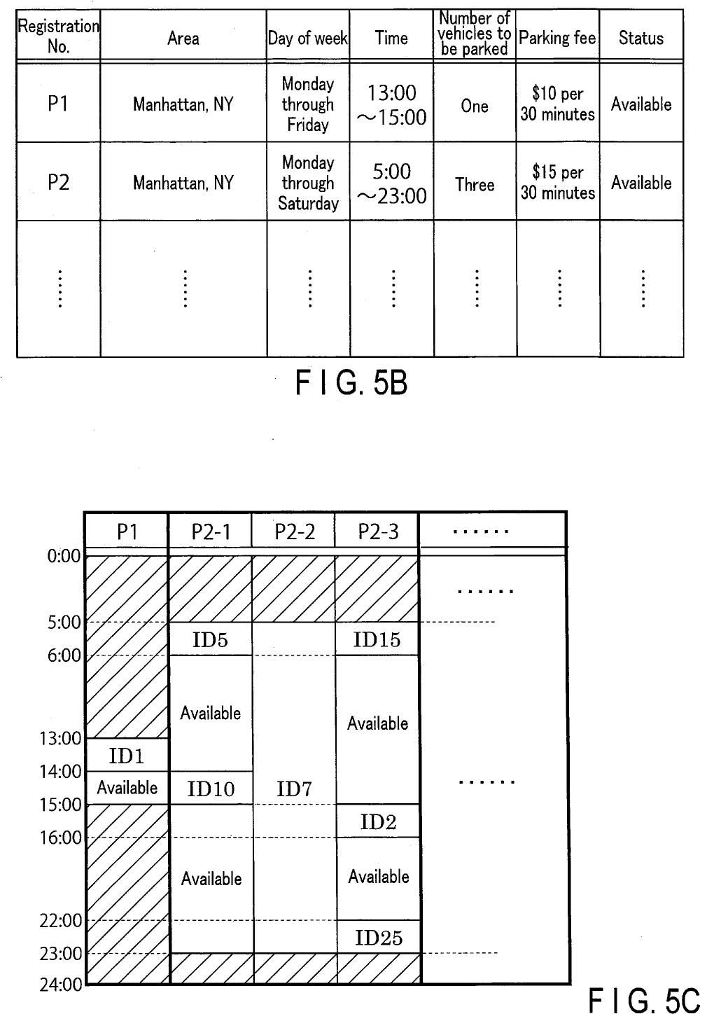

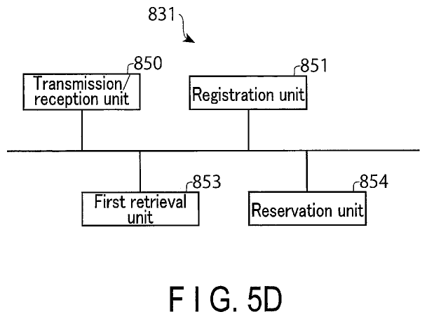

The configuration of the server 800 will be described with reference to FIG. 5A. FIG. 5A is a block diagram showing an example of the configuration of the server 800. As shown in FIG. 5A, the server 800 includes a control unit 830 and a communication unit 870.

The communication unit 870 transmits and receives information to and from the server 600 and the smartphone 200 by wireless communication, for example. For example, the communication unit 870 receives a parking lot information request and a parking lot reservation request from the server 600, and also receives a parking lot registration request from the smartphone 200. In addition, the communication unit 870 transmits the parking lot information and reservation completed information from the control unit 830 to the server 600, and transmits the registration completed information to the smartphone 200.

The control unit 830 stores information about the parking lot 100 managed by a parking lot scheduling company in real time, and assigns a necessary parking lot 100 to each vehicle 300 as required. That is, the control unit 830 includes a processor 831 such as a CPU, a ROM 832, a RAM 833 and an input/output circuit 834. The ROM 832 stores programs executed by the processor 831 and necessary data. The RAM 833 functions as a work area of the processor 831 and stores a parking lot reservation program 835, parking lot contract information 836 and a reservation timetable 837. The parking lot contract information 836 includes information regarding contents of a contract exchanged between the owner of the vehicle and the owner of the parking lot 100 and the current state of vacant cars. The reservation timetable 837 includes information regarding the reservation status of each parking lot 100. The input/output circuit 834 controls transmission and reception of information to and from the communication unit 870. The processor 831 executes the program 835 to perform a process for the parking lot reservation system. That is, the processor 831 uses the parking lot contract information 836 to manage the contents of contract with the owner of the parking lot 100, the rental conditions of the parking lot 100 and the like, and also uses the reservation timetable 837 to manage the reservation status of the parking lot 100.

FIG. 5B is a conceptual diagram of the parking lot contract information 836. As shown in FIG. 5B, the parking lot contract information 836 includes a registration number, an area, an available day of the week and time, the number of available parking lots, a parking fee and a current status for each parking lot 100. In the example of FIG. 5B, the parking lot with registration number P1 is located in Manhattan, USA, and is available for one vehicle on Monday through Friday 13:00 to 15:00 every week. The parking fee is $1 per 30 minutes. The parking lot is currently available. The parking lot with registration number P2 is located in Manhattan, USA, and is available for three vehicles on Monday through Saturday 5:00 to 23:00 every week. The parking fee is $15 per 30 minutes. The parking lot is currently available. Of course, the parking lot contract information 836 may include information on the owner of the parking lot 100, agreement information on a contract period, and the like.

For the sake of simplifying the expressions in the following description, when a plurality of parking lots 100 are distinguished from one another, a parking lot 100 whose registration number is Pj (j is a natural number) may be referred to as “parking lot Pj.”

FIG. 5C is a conceptual diagram of the reservation timetable 837 and corresponds to FIG. 5B. As shown in FIG. 5C, the timetable 837 includes information about hourly availability of each parking lot 100. In the example of FIG. 5C, the hatched portions indicate time periods over which the parking lots are unavailable. The parking lot P1 is available over the period of 13:00 to 15:00 as described with reference to FIG. 5B, but it is reserved by vehicle ID1 during the period of 13:00 to 14:00, and it is available over the period of 14:00 to 15:00. The parking lot P2 includes three parking spaces P2-1, P2-2 and P2-3. The parking space P2-1 is reserved by vehicle ID5 over the period of 5:00 to 6:00 and reserved by vehicle ID10 over the period of 14:00 to 15:00. The parking space P2-2 is reserved by vehicle ID7 over the period of 5:00 to 23:00, and there is no available time period. The parking space P2-3 is reserved by vehicle ID15 over the period of 5:00 to 6:00, reserved by vehicle ID2 over the period of 15:00 to 16:00, and reserved by vehicle ID25 over the period of 22:00 to 23:00.

Upon receiving a parking lot registration request from, for example, the smartphone 200 of the owner of the parking lot 100, the processor 831 requests the smartphone 200 to provide various items of information necessary for managing the parking lot 100. Once the necessary information items are transmitted from the smartphone 200 to the server 800 to make a contract between the parking lot scheduling company and the owner of the parking lot, the processor 831 transmits registration completed information to the smartphone 200. Further, the processor 831 registers the parking lot 100 in the parking lot contract information 836 shown in FIG. 5B. As a result, the owner of the parking lot can rent the parking lot to others through the parking lot scheduling company.

FIG. 5D is a functional block diagram of the processor 831 (or the entire control unit 830) while the parking lot reservation program 835 is being executed. As shown in FIG. 5D, the processor 831 executes the program 835 to function as a transmission/reception unit 850, a registration unit 851, a first retrieval unit 853 and a reservation unit 854.

The transmission/reception unit 850 receives, for example, a request for parking lot information and a request for parking lot reservation from the server 600 via the communication unit 870 and receives a request for parking lot registration from the smartphone 200 via the communication unit 870. The transmission/reception unit 850 also transmits the parking lot information and reservation completed information to the server 600, and transmits registration completed information to the smartphone 200.

When the server 800 receives a parking lot registration request from the smartphone 200, the registration unit 851 makes a contract between the parking lot scheduling company and the owner of the parking lot 100 to manage the parking lot 100. If the contract is established, the registration unit 851 registers the parking lot 100 in the server 800. More specifically, as described with reference to FIG. 5B, a registration number is assigned to the parking lot 100, and information necessary for selecting the parking lot is registered in the parking lot contract information 836. As described with reference to FIG. 5C, the parking lot 100 is registered in the reservation timetable 837. The parking lot 100 can thus be reserved. In accordance with the contents of the contract, the parking lot scheduling company pays a parking fee to the owner of the parking lot.

The first retrieval unit 853 retrieves the parking lot 100 located on the way to a destination based on the parking lot contract information 836 and the reservation timetable 837. The reservation unit 854 reserves the parking lot 100 found by the first retrieval unit 853 without waiting for an instruction from the user.

### 1.2 Operation

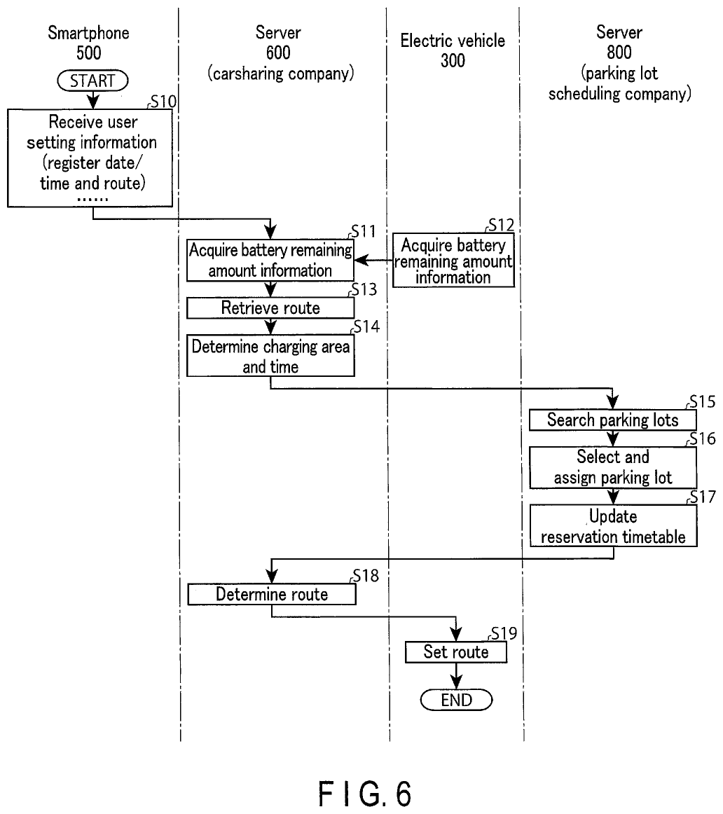

The operation of the parking reservation system 1 for electric vehicles according to the first embodiment will be described below with reference to FIG. 6. FIG. 6 is a flowchart showing operations of the smartphone 500, server 600 (carsharing company), server 800 (parking lot scheduling company) and electric vehicle 300 with respect to the reservation for the parking lot 100, which are performed when a user rides the electric vehicle 300 or when the user decides to ride the electric vehicle 300 (the user may ride it on the next day, for example). Note that the process of the server 600 is performed mainly by the control unit 630 when the processor 631 executes the program 635, and the process of the server 800 is performed mainly by the control unit 830 when the processor 831 executes the program 835.

As shown in FIG. 6, the smartphone 500 first receives user setting information 536 from the user (step S10). That is, the smartphone 500 receives information regarding ride date and time and the route (destination and stopover) from the user. During this process, the smartphone may receive, for example, priority information on route retrieval for each user, such as prioritizing an expressway over a general road.

The smartphone 500 transmits the information 536 to the server 600, and the server 600 stores the received information 536 in the RAM 633. Then, the server 600 selects one of the vehicles 300 owned by the carsharing company and acquires the battery remaining amount information 339 of the selected vehicle (step S11). That is, the server 600 transmits a battery remaining amount request to the vehicle 300. In the vehicle 300, the battery monitoring unit 320 acquires the remaining amount of the battery 310 and transmits the acquired battery remaining amount information 339 to the server 600 (step S12).

Subsequently, the server 600 acquires traffic jam information 638, and retrieves a travel route to the destination based on the acquired traffic jam information 638 and user setting information 536 (step S13). In this route retrieval, based on the battery remaining amount information 339, the server 600 further determines whether the battery 310 needs to be charged on the way to the destination of the vehicle 300. If the server 600 determines that the battery 310 needs to be charged, it determines an approximate area and time to perform charging based on the travel route acquired in step S13 (step S14). The server 600 then issues a reservation request for the parking lot 100 together with the area and time determined in step S14, and transmits it to the server 800. At this time, the travel route acquired in step S13 and the vehicle ID of the vehicle 300 for which the reservation request has been issued, may also be transmitted.

The server 800 that has received the reservation request searches the parking lots 100 which satisfy the request of the server 600, based on the parking lot contract information 836 and the reservation time table 837 (step S15). Then, the server 800 selects a parking lot 100 based on the search result in step S15, and assigns the selected parking lot 100 to the vehicle 300 (step S16). The server 800 also updates the reservation timetable 837 (step S17) and reserves the parking lot 100 assigned in step S16 for the vehicle 300 for at least a time period required for charging. The server 800 then transmits to the server 600 reservation completed information 640 indicating that the reservation is completed and information 639 regarding the reserved parking lot.

Then, the server 600 determines the travel route based on the reserved parking lot 100 (step S18). Then, the server 600 sets the determined travel route to the vehicle 300 (step S19). The server 600 may transmit not only the travel route information 336 but also the reserved parking lot information 337 to the vehicle 300.

### 1.3 Advantages of First Embodiment

The first embodiment makes it possible to use a parking lot with efficiency. This advantage will be described below.

Carsharing services have become widespread in recent years. As the services become more widespread, it is more likely that people will not own their cars, and cars may become common property. In addition, as automated driving technology develops and driverless cars can be driven, cars may increasingly play a role as public transportation rather than private property. In such an era, electric vehicles may be more widespread worldwide than vehicles powered by fossil fuel internal combustion engines, such as gasoline vehicles.

If the age comes, the value of a home parking lot to park a car may be lost because there is no longer a need to own a car. On the other hand, if electric vehicles are widespread, there is a problem that a number of power supply stations for charging the batteries of electric vehicles have to be installed everywhere.

In view of the above, in the first embodiment, privately owned parking lot is used not only as a parking lot but also as a charging station. To achieve this, the parking lot scheduling company (server 800) manages individuals' owned parking lots. The carsharing company (server 600) which owns electric vehicles and manages the travel route and operating schedule of the vehicles issues a parking lot reservation request to the server 800 together with the travel route information, the area and the time. Then, the server 800 reserves a parking lot that is most suitable for the reservation request. The parking lot is not simply a space to park the vehicle but has the ability to charge the battery of the vehicle. The server 800 thus reserves the parking lot only for a period necessary for charging the battery. When the vehicle arrives at the destination, it may be parked in the parking lot until the next ride, but it moves to the next destination in response to a next user's request. When the user goes home, another vehicle comes to pick up the user. That is, the vehicles almost function as public transportation. As a result, a privately owned parking lot can be used as a charging station and has only to be occupied only for a period necessary for charging. The parking lot can thus be used with efficiency.

### 2. SECOND EMBODIMENT

Next is a description of an information processing device, an information processing method and an information processing program according to a second embodiment. The second embodiment relates to a method for setting a parking fee by the parking lot scheduling company in the parking lot reservation system described in the first embodiment. The second embodiment will be described, paying attention to only the points different from those of the first embodiment.

### 2.1 Configuration of Server 800

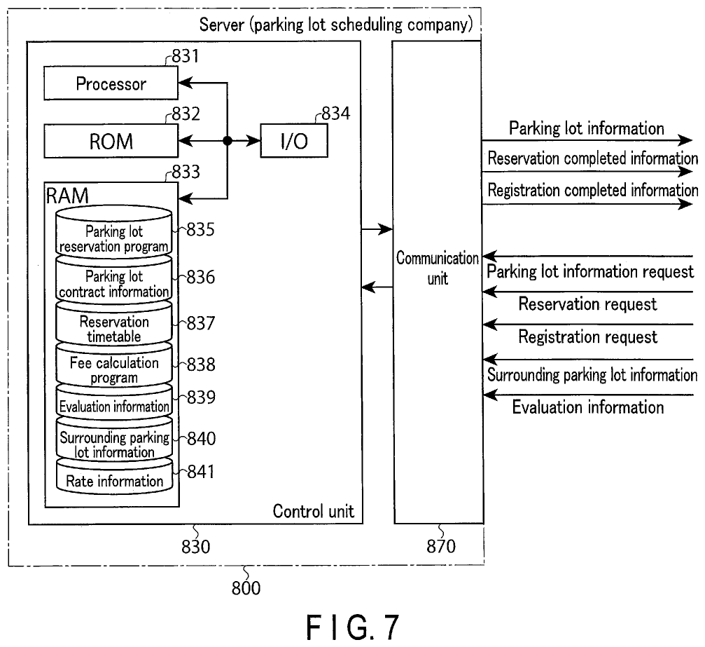

FIG. 7 is a block diagram of a server 800 of the parking lot scheduling company. As shown in FIG. 7A, in the server 800 shown in FIG. 5A described in the first embodiment, the RAM 833 further stores a fee calculation program 838, evaluation information 839, surrounding parking lot information 840 and rate information 841.

The evaluation information 839 is information regarding the evaluation of each parking lot 100 managed by the parking lot scheduling company (server 800). The evaluation information 839 is transmitted to the server 800 from the smartphone 500 of the user who uses the parking lot 100, for example. An example of the method of evaluating the parking lot 100 will be described in detail in the eighth embodiment.

The surrounding parking lot information 840 is information regarding surrounding parking lots of each parking lot 100 managed by the parking lot scheduling company (server 800). The surrounding parking lot information 840 includes the number of surrounding parking lots, the number of cars that can be parked, the availability of parking lots, parking fees, and the like.

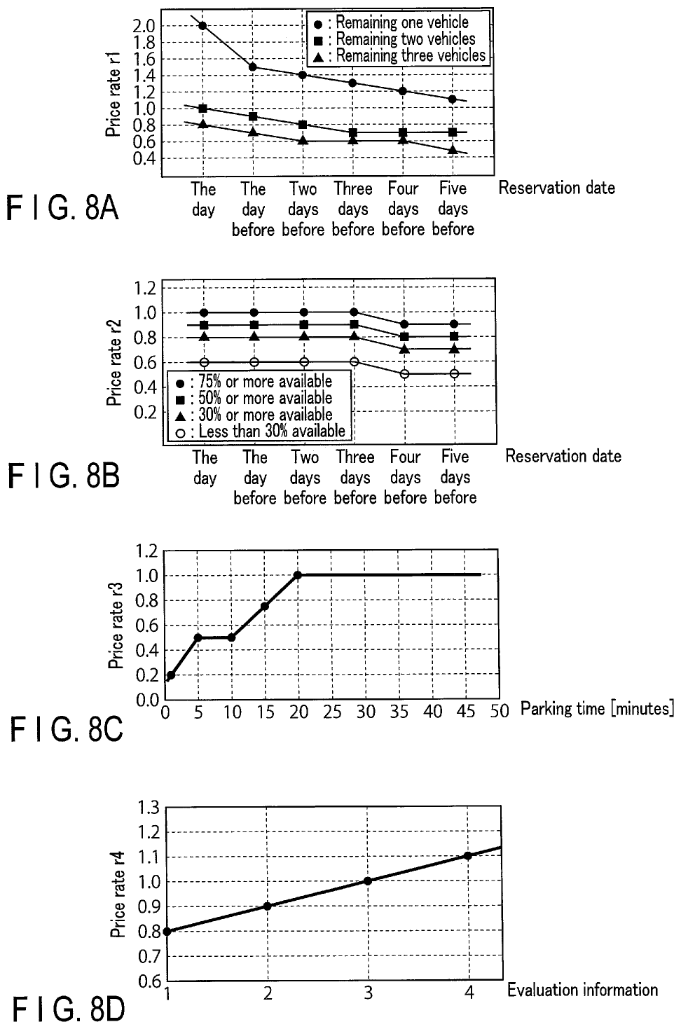

The rate information 841 is information regarding a price rate used for calculating a parking fee when a plurality of situations are assumed for the parking lot 100. A specific example of the rate information 841 will be described with reference to FIGS. 8A to 8D. FIGS. 8A to 8D are conceptual diagrams of the rate information 841 and show price rates r1 to r4 in four scenarios.

FIG. BA shows an example of a first scenario in which the price rate r1 is determined from the relationship between the available state of a target parking lot 100 and the reservation date. As shown in FIG. 8A, when the reservation date is the same as the date of use of the parking lot, the price rate r1 is 2.0 if the number of available parking spaces is one, it is 1.0 if the number is two, and it is 0.8 if the number is three. The parking fee of the parking lot 100 can be calculated, for example, by multiplying a standard fee by the price rate. Therefore, when the dates of reservation and use are the same, the parking fee is the standard fee if the number of available parking spaces is two, and it is smaller than the standard fee if the number if three, but it is double the standard fee and higher if the number is only one. The earlier the reservation date, the lower the price rate.

FIG. 8B shows an example of a second scenario in which the price rate r2 is determined from the relationship between the available state of surrounding parking lots of a target parking lot 100 and the reservation date. The available state of surrounding parking lots is obtained from the surrounding parking lot information 840, for example. Alternatively, the available state of surrounding parking lots may be predicted by the processor 831 in accordance with the number of vehicles traveling around the target parking lot 100 and the number of vehicles heading for an area where the parking lot 100 is located. The number of vehicles may be estimated by the processor from images received by the server 800 from a camera installed on a road, for example, or may be obtained from an operator who provides traffic jam information. As shown in FIG. 8B, the smaller the number of available surrounding parking lots, the lower the price rate. For example, when the dates of reservation and use for the parking lot are the same, the price rate r2 is 1.0 if 75% or more of the parking spaces in the surrounding parking lots are available, it is 0.9 if 50% or more of the parking spaces are available, it is 0.8 if 30% or more of the parking spaces are available, it is 0.6 if the number of available parking spaces is smaller than 30%. The earlier the reservation date, the lower the price rate. The reason why the parking fee is made lower as the surrounding parking lots are more crowded as in this example is to resolve a full-parking problem by moving the vehicles parked in occupied parking lots to the parking lot 100 (which is called “mediation”). Details of the mediation will be described in the fourth and fifth embodiments.

FIG. 8C shows an example of a third scenario in which the price rate r3 is determined in accordance with user's desired parking time in a target parking lot 100. As shown in FIG. 8C, the shorter the parking time (i.e., the charging period), the lower the price rate r3. If the parking fee is set small for the short-time use, the use of the parking lot 100 in spare time can be promoted and its efficiency can be improved.

FIG. 8D shows an example of the fourth scenario in which the price rate r4 is determined in accordance with the evaluation information 839 of a target parking lot 100. The evaluation information 839 is expressed as numerical values of 1, 2, 3, . . . , for example. Assume that the higher the numerical value, the higher the evaluation. In this case, the higher the evaluation, the higher the price rate r4.

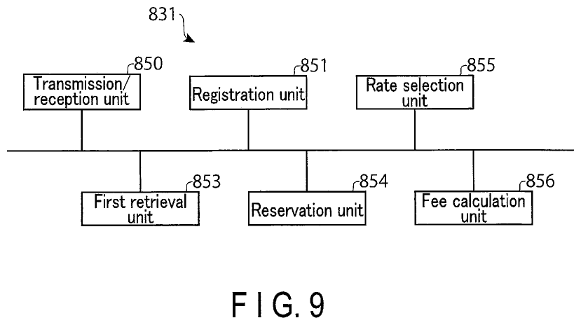

The fee calculation program 838 is executed by the processor 831. The processor 831 executes the program 838 to calculate a parking fee of the parking lot 100 to be managed. The fee calculation program 838 may be part of the parking lot reservation program 835 or may be a different program. FIG. 9 is a functional block diagram of the processor 831 (or the entire control unit 830) performed while the programs 835 and 838 are being executed. As shown in FIG. 9, the processor 831 executes the program 838 to function as a rate selection unit 855 and a fee calculation unit 856 in FIG. 5D described in the first embodiment.

The rate selection unit 855 selects a price rate to be used based on the rate information 841. For example, one or all of the first to fourth scenarios described with reference to FIGS. 8A to 8D are selected.

The fee calculation unit 856 calculates a parking fee based on the scenario selected by the rate selection unit 855 and the parking lot contract information 836. When a plurality of scenarios are selected, for example, each of the scenarios is weighted to determine a price rate to be used finally.

### 2.2 Operation

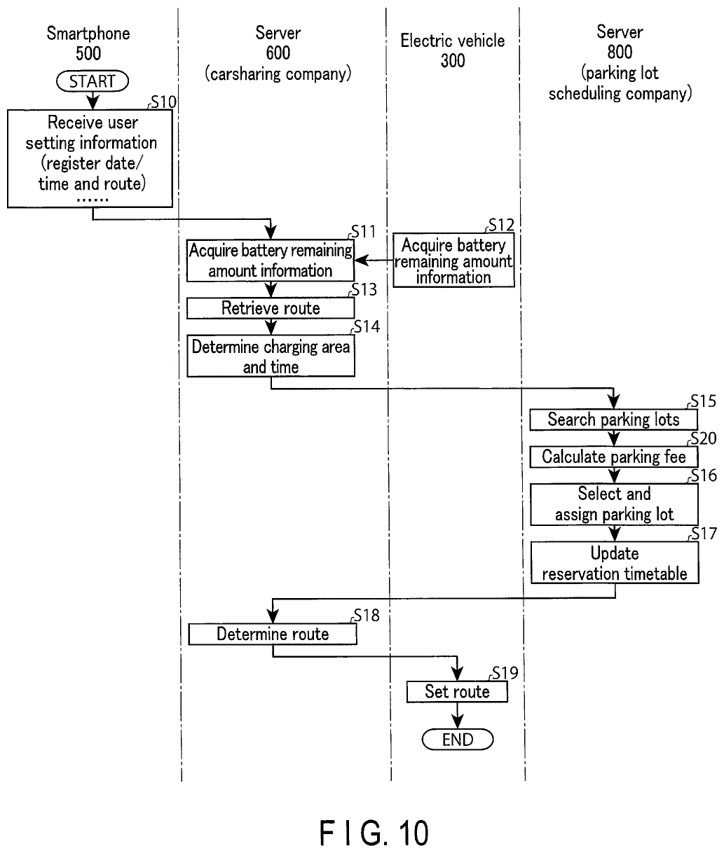

FIG. 10 is a flowchart showing an operation of a parking lot reservation system 1 according to the second embodiment, and corresponds to FIG. 6 described in the first embodiment.

As shown in FIG. 10, the server 800 searches the parking lots 100 in step S15 and then calculates a parking fee (step S20). Then, the server 800 selects a parking lot 100 and assigns it to a vehicle 300 that has transmitted a parking lot reservation request (step S16). In steps S15, S20 and S16, the first retrieval unit 853 may retrieve a plurality of parking lots 100 and the rate selection unit 855 may select a price rate to be applied to the found parking lots 100. The fee calculation unit 856 calculates a parking fee for each of the parking lots 100, and the reservation unit 854 selects one of the parking lots on the basis of the calculated parking fees and makes a reservation. A specific example of this operation will be described in detail in the third embodiment.

### 2.3 Advantages of Second Embodiment

According to the second embodiment, the server 800 of the parking lot scheduling company calculates and determines a parking fee. The server 800 dynamically sets the parking fee based on the rate information 841 and the like. Thus, the parking lots can be further improved in their use efficiency.

As described in the first embodiment, it is expected in the future that a privately owned parking lot will serve as a charging station for vehicles owned by the carsharing company, not as a parking lot exclusively for a privately owned vehicle. In order to achieve convenience for the user of the vehicle 300, it is desirable that an operator such as a parking lot scheduling company manages a plurality of parking lots in a unified manner. In the second embodiment, the parking lot scheduling company also sets a parking fee for the parking lots 100. The parking lot scheduling company dynamically sets a parking fee for each of the parking lots 100 based on the relationship between demand and supply. That is, the parking fee is the current price.

The parking lot scheduling company sets an appropriate parking fee using the evaluation information 839, surrounding parking lot information 840 and rate information 841. The appropriate parking fee is an amount of money that is suitable for both the customers of the vehicle 300 and the owners of the parking lots 100. Thus, the parking lots 100 can efficiently be used, the convenience of the customers of the vehicle 300 can be improved, and the owners of the parking lots 100 can efficiently be benefited.

### 3. THIRD EMBODIMENT

Next is a description of an information processing device, an information processing method and an information processing program according to a third embodiment. The third embodiment relates to a specific method of assigning a parking lot 100 to a vehicle 300 by a parking lot scheduling company in the first and second embodiments. The third embodiment will be described, paying attention to only the points different from those of the first and second embodiments.

### 3.1 Configuration of Server 600

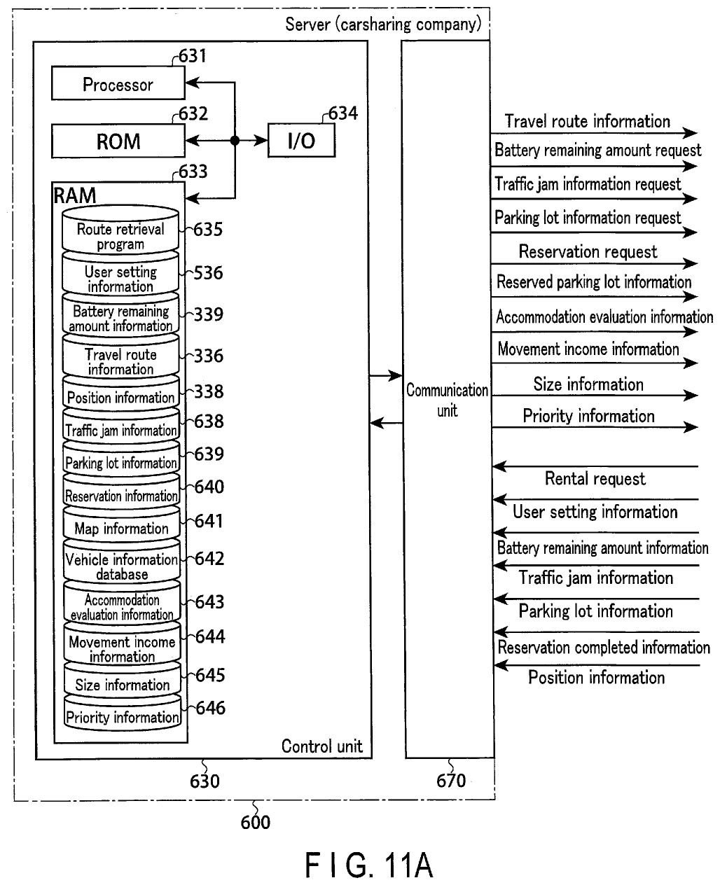

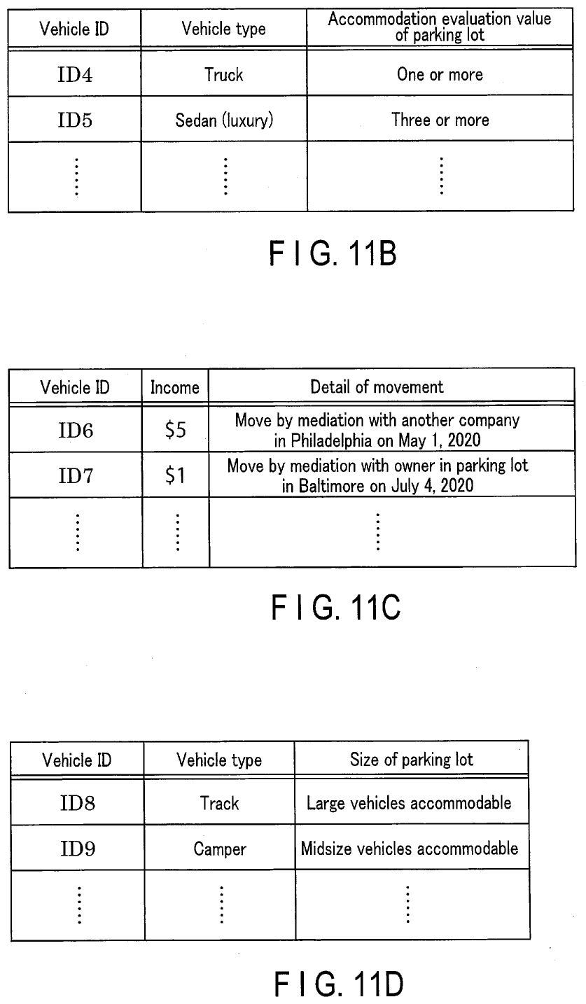

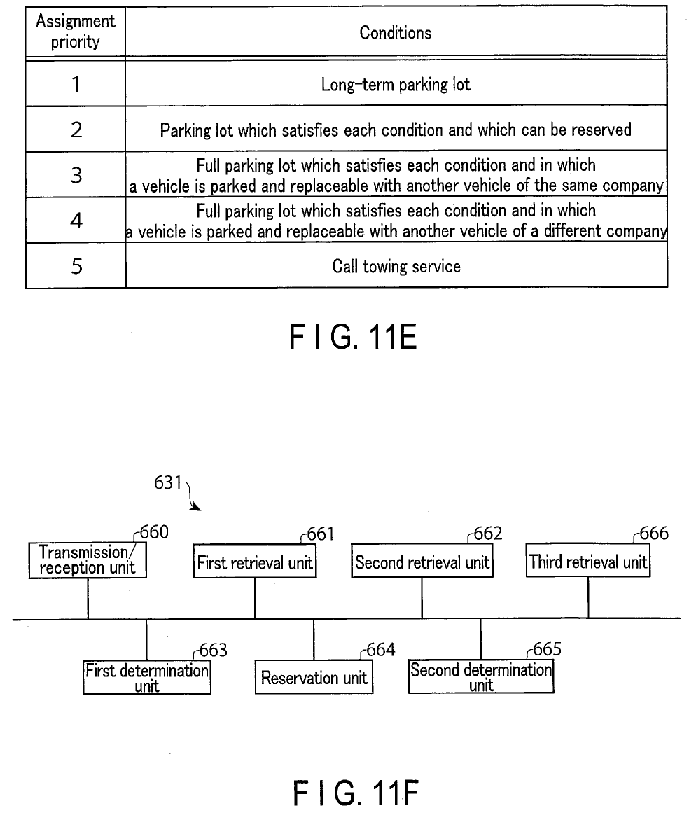

FIG. 11A is a block diagram of a server 600 of the car sharing company. As shown in FIG. 11A, in the server 600 shown in FIG. 4A described in the first embodiment, the RAM 633 further stores accommodation evaluation information 643, movement income information 644, size information 645 and priority information 646.

The accommodation evaluation information 643 holds information regarding an available parking lot 100 for each vehicle 300 managed by a carsharing company (server 600). FIG. 11B is a conceptual diagram showing an example of the accommodation evaluation information 643. As shown in FIG. 11B, the accommodation evaluation information 643 includes a vehicle type and an evaluation value of the available parking lot 100 for the vehicle ID of each vehicle 300. In this example, vehicle ID4 is a truck, which can be parked on a parking lot 100 whose evaluation value is not smaller than “1” that is the lowest value. This means that the available parking lot 100 does not depend on the evaluation value. Vehicle ID5 is a luxury sedan, and it can be parked in a parking lot 100 whose evaluation value is “3” or more. That is, it can park only in a parking lot 100 that is valued to some extent.

The movement income information 644 stores information regarding the income obtained by mediation and movement in the past for each vehicle 300 managed by the carsharing company. As described above, the mediation means that when a vehicle 300-1 is to be parked on the parking lot 100 that is occupied, one (300-2) of the vehicles moves from the parking lot to be replaced with the vehicle 300-1. Since the vehicle 300-2 which provides the vehicle 300-1 with the parking space needs to move for another parking lot, the user of the vehicle 300-2 can receive a charge commensurate with the movement from the user of the vehicle 300-1 or the carsharing company. FIG. 11C is a conceptual diagram showing an example of the movement income information 644. In the example of FIG. 11C, a vehicle ID6 earns an income of $5 in accordance with mediation with a vehicle managed by a carsharing company other than the carsharing company that manages the vehicle ID6. A vehicle ID7 earns an income of $1 by moving from the parking lot 100 at the request of the owner of the parking lot owner.

The size information 645 stores information regarding the size of an available parking lot 100 for each of the vehicles 300 managed by the carsharing company. FIG. 11D is a conceptual diagram showing an example of the size information 645. As shown in FIG. 11D, the size information 645 includes a vehicle type and the size of parking lot 100 for the vehicle ID to be accommodated of each of the vehicles 300. In this example, vehicle ID8 is a truck, which can be parked on a parking lot 100 corresponding to a large vehicle. That is, it cannot be parked in a parking lot 100 for passenger automobiles such as sedans. Vehicle ID 9 is a camper, which can be parked in a parking lot 100 corresponding to a midsize vehicle (or a midsize or larger vehicle). That is, the camper cannot be parked in a parking lot for passenger automobiles like the vehicle ID8, but does not require a large parking lot for a large vehicle.

The priority information 646 stores information regarding priority when a parking lot 100 is selected. FIG. 11E is a conceptual diagram showing an example of the priority information 646. As shown in FIG. 11E, the priority information 646 includes an assignment priority and its conditions. In this example, the parking lot 100 having the highest assignment priority is a long-term parking lot contracted by the carsharing company. The next highest priority parking lot 100 is an occupied parking lot 100 which satisfies other conditions, such as evaluation values and size, in which a vehicle 300 managed by the same carsharing company is parked, and which can be mediated with the vehicle 300. The next highest priority parking lot 100 is an occupied parking lot 100 which satisfies other conditions, such as evaluation values and size, in which a vehicle 300 managed by a different carsharing company is parked, and which can be mediated with the vehicle 300. If there are no parking lots 100 that satisfy the above conditions, a towing service for another vehicle 300 is called in one of the parking lots 100.

FIG. 11F is a functional block diagram of a processor (or the entire control unit 830) to be operated when a parking lot reservation program 835 according to the third embodiment is executed. As shown in FIG. 11F, the processor 831 further functions as a third determination unit 666 in the configuration of FIG. 4C described in the first embodiment. The reservation unit 664 issues a reservation request for a parking lot together with the accommodation evaluation information 643, movement income information 644, size information 645, priority information 646, and the like. The third determination unit 666 determines whether one of the parked vehicles 300 can be moved. If necessary, the third determination unit 666 requests the parked vehicles 300 to move from the parking lot 100.

### 3.2 Configuration of Server 800

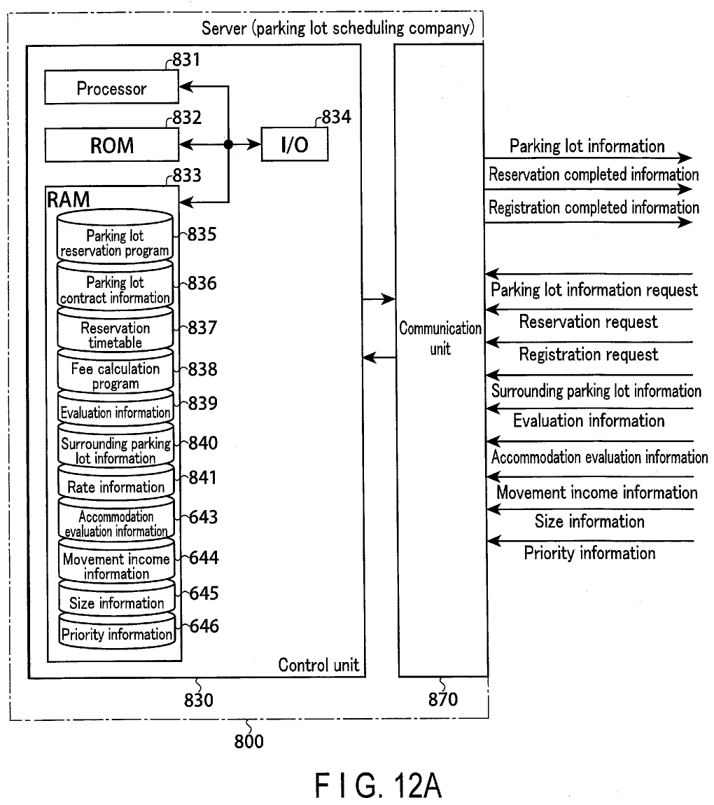

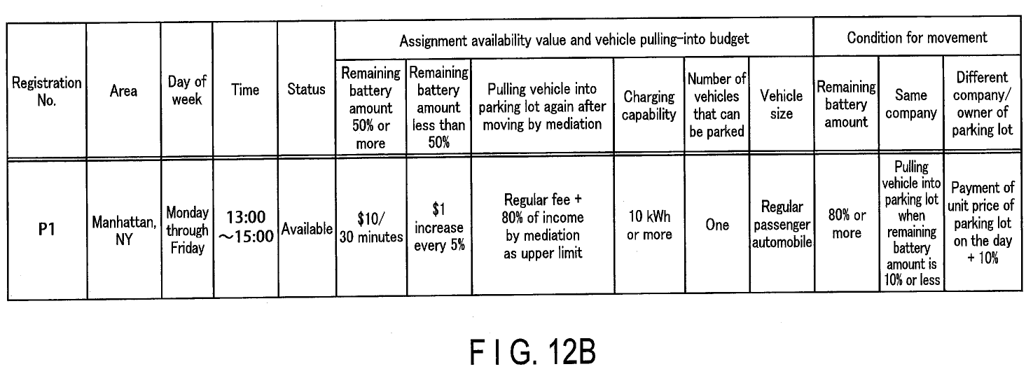

The configuration of a server 800 of the parking lot scheduling company according to the third embodiment will be described with reference to FIG. 12A. FIG. 12A is a block diagram of the server 800 according to the third embodiment. As shown in FIG. 12A, the server 800 further stores accommodation evaluation information 643, movement income information 644, size information 645 and priority information 646. These information items are transmitted from the server 600 together with the reservation request for the parking lot 100 and are related to a vehicle 300 corresponding to the reservation request.

FIG. 12B is a conceptual diagram of parking lot contract information 836 according to the third embodiment particularly for a parking lot whose registration number is P1. FIG. 12B corresponds to FIG. 5B described in the first embodiment. As shown in FIG. 12B, the parking lot contract information 836 according to the third embodiment includes detailed conditions for assignment of parking lots and conditions for moving by mediation.

The conditions for assignment will be described first. The conditions include information regarding a fee of the parking lot 100. In the example of FIG. 12B, when a vehicle 300 with a battery remaining amount of 50% pulls into the parking lot, the fee is $10 per 30 minutes (standard fee), but when the battery remaining amount is less than 45%, the fee is increased by $1 from the standard charge every 5%. That is, it is $11 per 30 minutes when the battery remaining amount is 45%, it is $12 per 30 minutes when the battery remaining amount is 40%, and so on. When a vehicle 300 that has moved from another parking lot 100 by mediation pulls into a parking lot, a parking fee is set appropriately with the standard fee plus 80% of the income obtained by the mediation as the upper limit. The conditions for assignment also include information regarding, for example, the facilities of the parking lot 100. In parking lot P1 shown in FIG. 12B, charging capability is 10 kWh or more, the number of vehicles that can be parked is one, and the size of a vehicle that can be parked is size of a regular passenger automobile.

Next is a description of conditions for movement by mediation. It is based upon the premise that the remaining battery amount of a vehicle 300 parked in the parking lot P1 is 80% or more for the vehicle 300 to move. The condition for moving in accordance with mediation with the vehicle 300 managed by the same carsharing company is that the remaining battery amount of the vehicle 300 is 10% or less. On the other hand, the condition for the vehicle 300 managed by a different carsharing company or the owner of the parking lot 100 to move in accordance with mediation is the payment of a fee obtained by adding 10% to the unit price of the parking lot 100 on the day.

The first retrieval unit 853 of the processor 831 described with reference to FIG. 5D retrieves parking lots 100 further in accordance with the parking lot contract information 836, reservation timetable 837, evaluation information 839, accommodation evaluation information 643, movement income information 644 and size information 645. The reservation unit 854 selects one of the found parking lots 100 in accordance with the priority information 646, for example, and reserves the selected one of the parking lots 100.

### 3.3 Operation

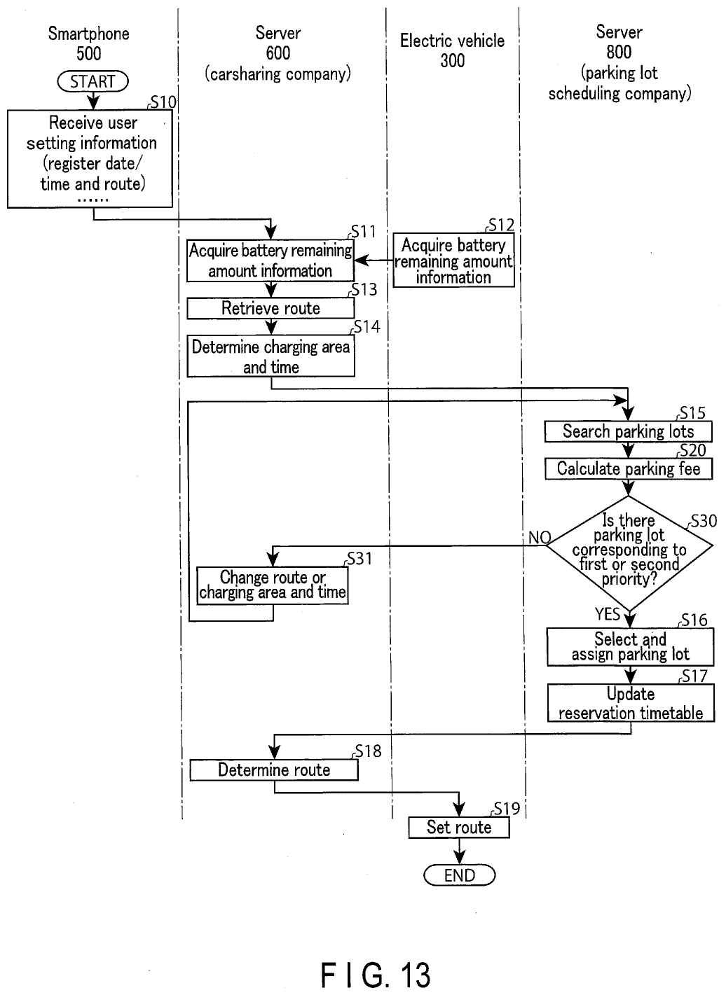

FIG. 13 is a flowchart showing an operation of a parking lot reservation system 1 according to the third embodiment, and corresponds to FIG. 6 described in the first embodiment and FIG. 10 described in the second embodiment. In the third embodiment, the case of mediation (third and fourth priorities) and the case of calling a towing service (fifth priority) are excluded from the assignment priority described with reference to FIG. 11E. These cases will be described in the fourth to sixth embodiments.

As shown in FIG. 13, the server 800 searches the parking lots 100 in step S15 and calculates a parking fee in step S20. If, for example, the reservation unit 854 refers to the priority information 646 to find a parking lot corresponding to the first or second priority described with reference to FIG. 11E (Yes in step S30), it reserves the parking lot 100 in steps S16 and S17. On the other hand, if the reservation unit 854 does not find a parking lot corresponding to the first or second priority (No in step S30), for example, the transmission/reception unit 850 of the server 800 issues a notice that no parking lot can be reserved and transmits it to the server 600 of the carsharing company. Then, the server 600 changes the route or the charging area and time obtained in steps S13 and S14 (step S31). Then, the server 600 issues a reservation request for the parking lot 100 together with the changed route or charging area and time, and transmits them to the server 800. The process of step S15 and its subsequent steps is repeated.

### 3.4 Advantages of Third Embodiment

According to the method described in the third embodiment, for example, the server 800 of the parking lot scheduling company described in the first and second embodiments can select a parking lot 100 and assign it to the vehicle 300.

### 4. FOURTH EMBODIMENT

Next is a description of an information processing device, an information processing method and an information processing program according to a fourth embodiment. The fourth embodiment relates to a method of mediation between vehicles in the same company, which corresponds to the third assignment priority described with reference to FIG. 11E in the third embodiment. The fourth embodiment will be described, paying attention to only the points different from those of the first to third embodiments.

### 4.1 Specific Example

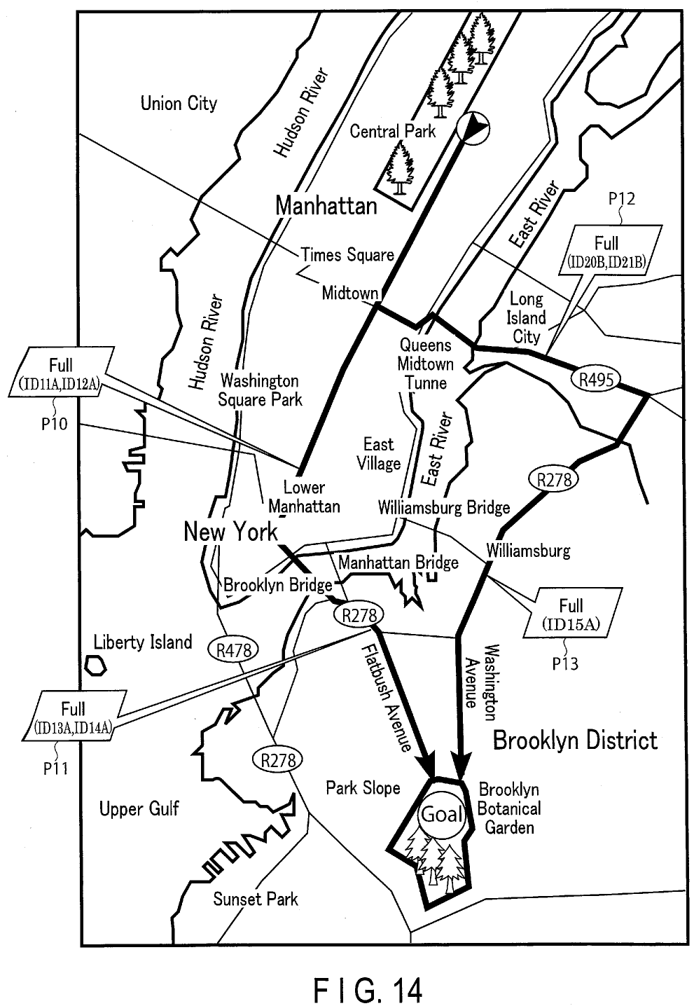

The fourth embodiment as well as the fifth and sixth embodiments to be described later will be described with a specific example to facilitate understanding. FIG. 14 is a map showing, in the form of a model, a travel route of a vehicle 300 with vehicle ID10A managed by carsharing company AAA and a parking lot 100 found in response to the request of the vehicle 300.

Assume that the vehicle 300 leaves Central Park in Manhattan for the Brooklyn Botanical Garden as shown in FIG. 14. Also, assume that the server 600 of the company AAA uses two routes as candidate travel routes. Also, assume that in each of the routes, the server 800 of the parking lot scheduling company extracts parking lots P10 and P11 and parking lots P12 and P13. Details of the routes and parking lots are as follows.

(1) Route 1: The vehicle leaves Central Park, goes straight through Midtown, crosses the Brooklyn Bridge, and arrives at the Brooklyn Botanical Garden through Route 278 Flatbush Avenue.

Parking Lot P10
Location: Lower Manhattan
Status: Full
Parked Vehicles: Two vehicles (ID11A, ID12A) of company AAA

Parking Lot P11
Location: Flatbush Avenue Entrance
Status: Full
Parked Vehicles: Two vehicles (ID13A, ID14A) of company AAA

(2) Route 2: The vehicle leaves Central Park, turns left at the intersection of Midtown, passes Long Island City through the Queens Midtown Tunnel, and goes to Route 278 from Route 495, passes Williamsburg, and arrives at the Brooklyn Botanical Garden through Washington Avenue.

Parking Lot P12
Location: Long Island City
Status: Full
Parked Vehicles: Two vehicles (ID20B, ID21B) of another company (company BBB)

Parking Lot P13
Location: Williamsburg
Status: Full
Parked Vehicles: One vehicle (ID15A) of company AAA

### 4.2. Mediation Method

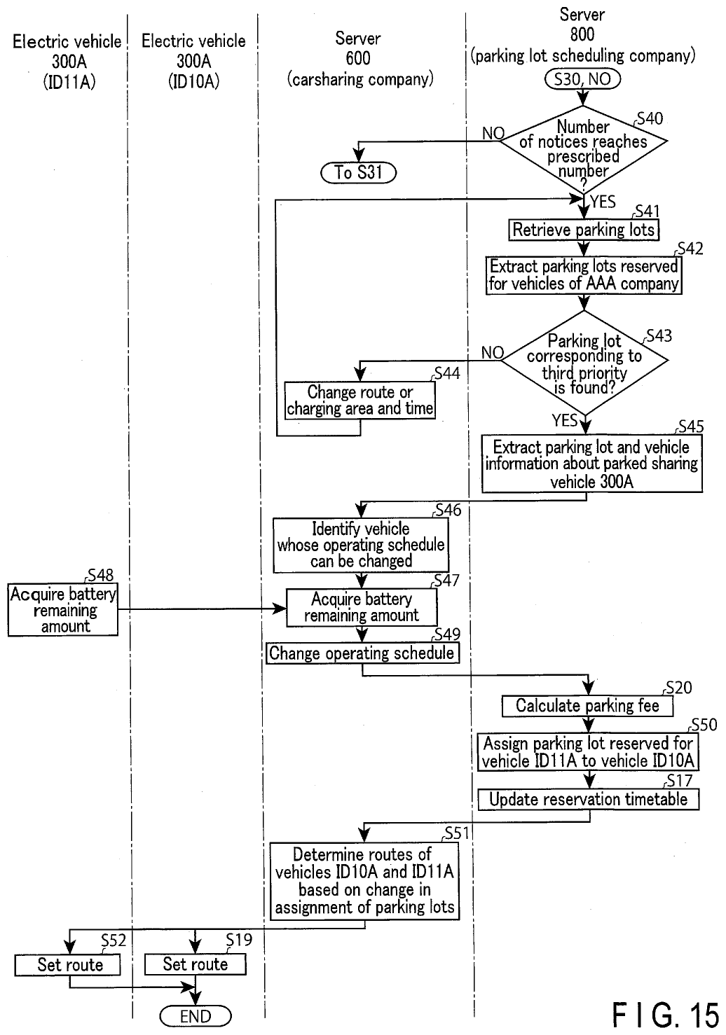

A method of mediating the parking lots 100 between the carsharing company (AAA) and the parking lot scheduling company in the example of FIG. 14, will be described with reference to FIG. 15. FIG. 15 is a flowchart corresponding to that of FIG. 13 described in the third embodiment and showing a flow of a process performed when there are no parking lots 100 corresponding to the first or second assignment priority in step S30 of FIG. 13 (NO in step S30).

As described in the third embodiment, when there are no parking lots 100 corresponding to the first or second assignment priority (NO in step S30), the server 800 issues a notice that no parking lot can be reserved to the server 600 to cause the server 600 to change the travel route or the charging area and time.

When the number of notices that no parking lot can be reserved reaches a prescribed number (YES in step S40), for example, the first retrieval unit 853 retrieves the parking lots 100 again (step S41) to extract parking lots 100 reserved for vehicles managed by the company AAA (step S42). For example, the reservation unit 854 searches the extracted parking lots 100 for a parking lot 100 corresponding to the third assignment priority described with reference to FIG. 11E (step S43). If there is no parking lot 100 corresponding to the third assignment priority (NO in step S43), for example, the reservation unit 854 issues a notice that no parking lot can be reserved and transmits it to the server 600. Then, the server 600 changes the travel route or the charging area and time (step S44). Then, the server 600 issues a reservation request for the parking lot 100 (a request for mediation between the vehicles of the company AAA) together with the changed route or charging area and time, and transmits them to the server 800. The server 800 repeats the process of step S41 and its subsequent steps.

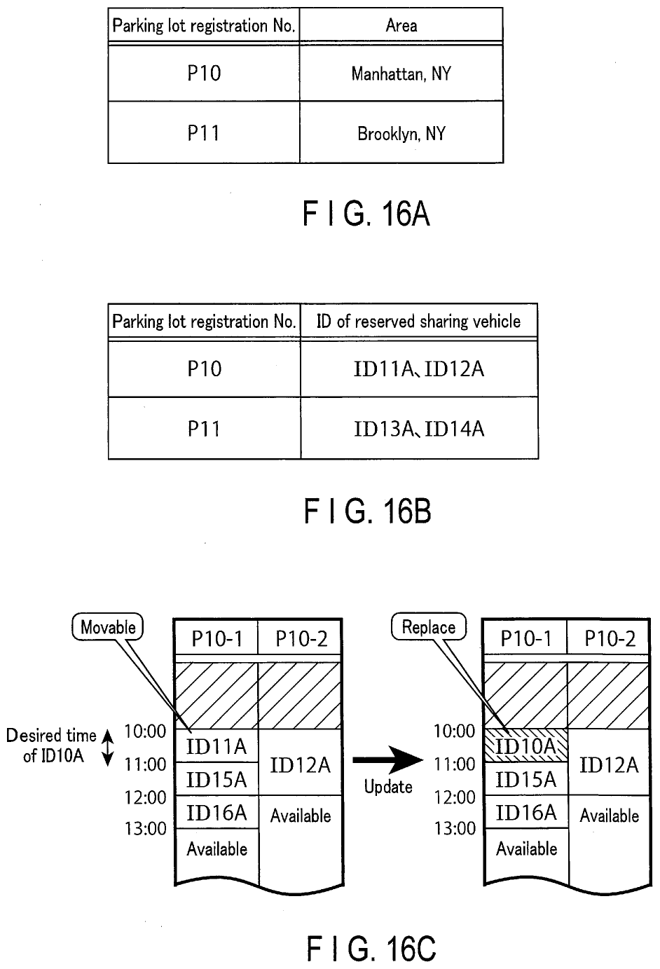

If a parking lot 100 corresponding to the third assignment priority is found in step 43 (YES in step S43), for example, the reservation unit 854 of the server 800 extracts information about the parking lot 100 from the parking lot contract information 836, and also extracts vehicle information about the parked vehicles 300 (hereinafter, the vehicles 300 managed by the company AAA will be referred to as vehicles 300A) from the timetable 837, for example (step S45). This extraction is shown in FIGS. 16A and 16B. In this example, for example, the parking lots 100 whose registration numbers are P10 and P11 described with reference to FIG. 14 are extracted, and the vehicle ID information of the vehicles 300A under reservation is also extracted from the reservation timetable 837. Then, for example, the transmission/reception unit 850 of the server 800 transmits an operating schedule change request to the server 600 together with the extracted information.

Then, for example, the third determination unit 666 of the server 600 identifies a vehicle whose operating schedule can be changed (step S46). That is, as shown in FIG. 16B, any one of the extracted vehicles 300A whose vehicles IDs are 11A, 12A, 13A and 14A is selected. Assume in this example that, for example, a vehicle ID11A is selected. The server 600 acquires the battery remaining amount information of the vehicle ID11A by the same method as in steps S11 and S12 described in the first embodiment (steps S47 and S48). Then, for example, the third determination unit 666 of the server 600 changes the operating schedule of the vehicle ID11A in accordance with the battery remaining amount information (step S49). For example, the travel route of the vehicle ID11A and the parking lot to be used are changed. When the change of the operating schedule is completed, the transmission/reception unit 660 transmits a change completed notice of the operating schedule to the server 800 together with the vehicle ID (vehicle ID11A in this example) of the vehicle 300A that responds to the mediation.

Upon receiving the change completed notice, the server 800 calculates a parking fee for parking the vehicle ID10A in the parking lot P10 after the vehicle IDilA is moved by mediation (step S20). The calculation method is as described in the second and third embodiments, for example. Then, the server 800 assigns the parking lot P10 reserved for the vehicle ID11A to the vehicle ID10A (step S50). Then, the reservation time table 837 is updated (step S17). This reservation is shown in FIG. 16C. FIG. 16C is a conceptual diagram of the reservation timetable 837.

As shown in FIG. 16C, the parking space P10-1 of the parking lot P10 is reserved by the vehicle ID11A during a time period of 10:00 to 11:00, reserved by the vehicle ID15A during a time period of 11:00 to 12:00, and reserved by the vehicle ID16A during a time period of 12:00 to 13:00. The other parking space P10-2 is reserved by the vehicle ID12A during a time period of 10:00 to 12:00. Assume in this situation that the customer of the vehicle ID10A wishes to park it during the time period of 10:00 to 11:00. If, then, the server 600 determines that the operating schedule of the vehicle ID11A can be changed, the server 800 cancels the reservation for the vehicle ID11A during the time period of 10:00 to 11:00 for the parking space P10-1, and sets a reservation for the vehicle ID10A instead. In addition, for the vehicle ID11A for which the reservation for the parking lot P10 is canceled, another parking lot may be reserved when necessary.

After that, as in the first embodiment, the server 800 transmits reservation completed information 640 indicating that the reservation is completed and information 639 regarding the reserved parking lot to the server 600. Based on the received information, the server 600 determines the travel routes of the vehicles ID10A and ID11A (step S51). Then, the server 600 sets the determined travel routes to the vehicles 300A whose vehicle ID numbers are ID10A and ID11A (steps S19 and S52).

### 4.3 Advantages of Fourth Embodiment

As described above, mediation between the vehicles 300 managed by the same carsharing company can be achieved by the method according to the fourth embodiment.

Mediation is needed when there is no available parking lot that meets the requirements. The mediation in the fourth embodiment makes it possible to park a vehicle in a desired parking lot while saving the trouble of searching parking lots in vain. Since the mediation is performed between the carsharing company and the parking lot scheduling company, the customers of the vehicles 300 need not recognize the mediation. Therefore, the mediation may contribute to further popularization of electric vehicles, without causing the customers to feel unnecessary anxiety.

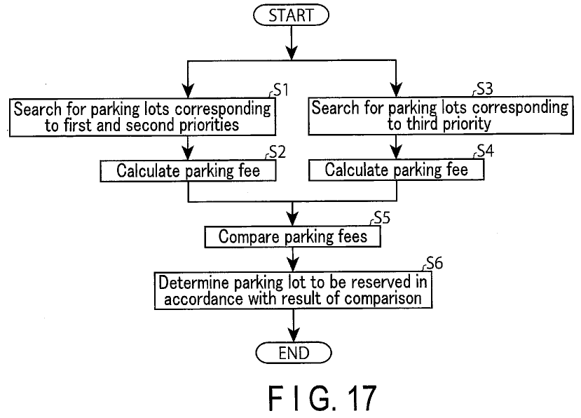

The above fourth embodiment is directed to the case of searching a parking lot 100 corresponding to the third assignment priority when no parking lots corresponding to the first and second assignment priorities are found. However, the parking lots corresponding to the first and second assignment priorities need not necessarily take precedence over the parking lot corresponding to the third assignment priority. This case is shown in the flowchart of FIG. 17.

As shown in FIG. 17, the server 800 of the parking lot scheduling company searches for parking lots corresponding to the first and second assignment priorities (step S1). If the parking lots are found, it calculates a parking fee (step S2). Further, the server 800 of the parking lot scheduling company searches for parking lots corresponding to the third assignment priority (step S3). If the parking lots are found, it calculates a parking fee (step S4). The server 800 then compares the parking fee obtained in step S2 with the parking fee obtained in step S4 (step S5). The server 800 determines a parking lot 100 to be reserved in accordance with a result of the comparison in step S5 (step S6). More specifically, a parking lot 100 with a small parking fee is reserved.

That is, if there are a plurality of candidate parking lots 100, the parking fee of parking lots corresponding to the first or second assignment priority may be larger than that of parking lots corresponding to the third assignment priority. In this case, a parking lot with a smaller parking fee can be selected by mediation.

### 5. FIFTH EMBODIMENT

Next is a description of an information processing device, an information processing method and an information processing program according to a fifth embodiment. The fifth embodiment relates to a method of mediation between vehicles of different companies, which corresponds to the fourth assignment priority described with reference to FIG. 11E in the third embodiment. The fifth embodiment will be described, paying attention to only the points different from those of the first to fourth embodiments. Like the fourth embodiment, the fifth embodiment will be described with reference to FIG. 14.

### 5.1 Overall Configuration

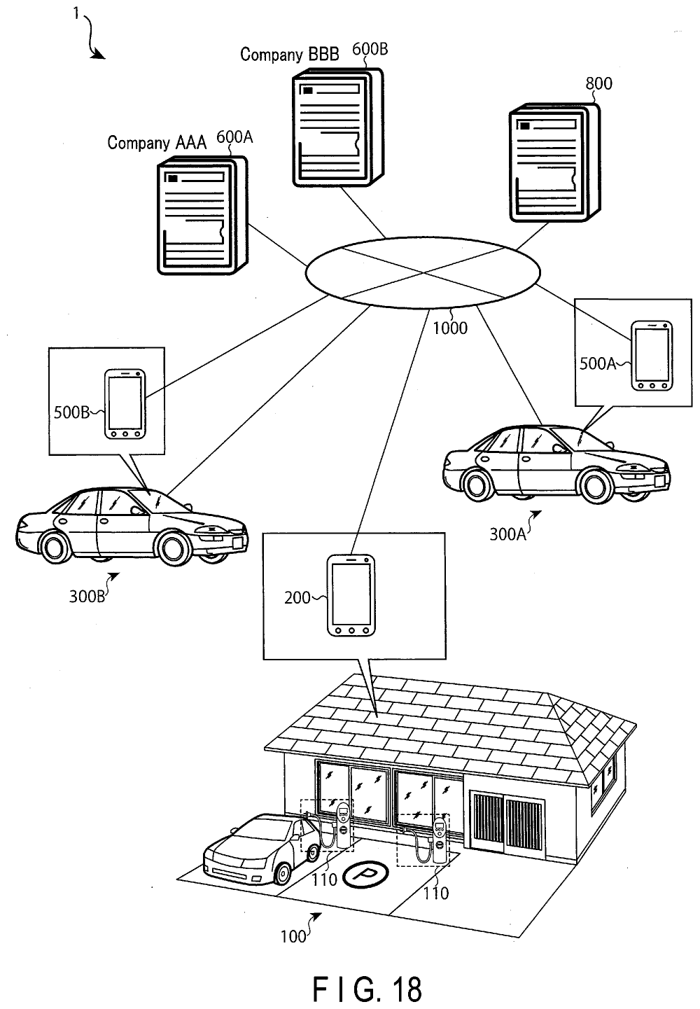

FIG. 18 shows an example of a configuration of a parking reservation system 1 according to the fifth embodiment. As shown in FIG. 18, the system 1 corresponds to the system described in the first embodiment where the vehicle 300 and server 600 of the first embodiment shown in FIG. 1 are replaced with vehicles 300A and 300B and servers 600A and 600B, respectively.

The server 600A is a management server of a carsharing company AAA, and the server 600B is a management server of another carsharing company BBB. The vehicle 300A is an electric vehicle managed by the carsharing company AAA, and the vehicle 300B is an electric vehicle managed by the carsharing company BBB.

The configuration of each of the servers 600A and 600B is the same as that of the server 600 described in the first to fourth embodiments. However, the server 600A naturally stores information regarding the vehicle 300A and manages the vehicle 300A based on this information. The server 600B stores information regarding the vehicle 300B and manages the vehicle 300B based on this information. The configuration of each of the vehicles 300A and 300B is also the same as that of the vehicle 300 described in the first to fourth embodiments. The vehicle 300A receives necessary information from the company AAA (server 600A) and is driven automatically under the control of the company AAA (server 600A). Similarly, the vehicle 300B receives necessary information from the company BBB (server 600B) and is driven automatically under the control of the company BBB (server 600B).

The configuration of the server 800 of the parking lot scheduling company is as described in the first to fourth embodiments. However, the parking lot scheduling company according to the fifth embodiment has a contract with a plurality of carsharing companies AAA and BBB. Accordingly, the parking lots 100 for the vehicles 300A and 300B are reserved in response to reservation requests from both the companies AAA and BBB.

### 5.2 Mediation Method

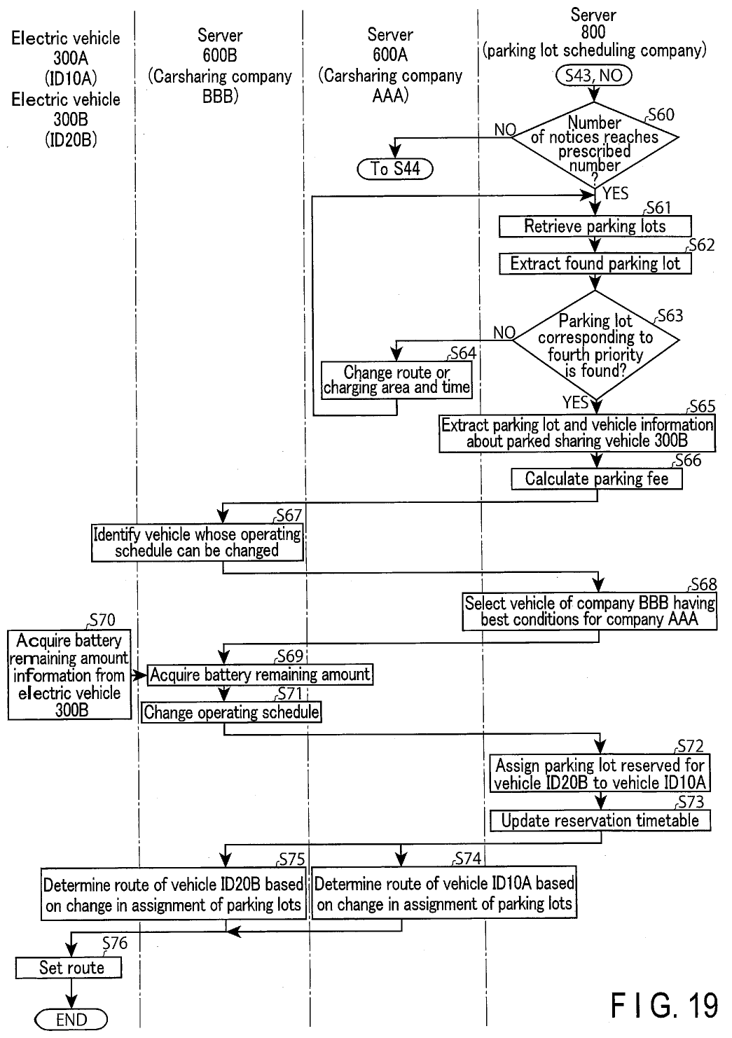

A method of mediating the parking lots 100 between the carsharing companies (AAA and BBB) and the parking lot scheduling company in the example of FIG. 14, will be described with reference to FIG. 19. FIG. 19 is a flowchart which corresponds to that of FIG. 13 described in the third embodiment and that of FIG. 15 described in the fourth embodiment and which shows a flow of a process performed when there are no parking lots 100 corresponding to the third assignment priority in step S43 of FIG. 15 (NO in step S43).

As described in the fourth embodiment, when there are no parking lots 100 corresponding to the third assignment priority (NO in step S43), the server 800 issues a notice that no parking lot can be reserved to the server 600 to cause the server 600A of the carsharing company AAA, which manages the vehicle ID10A, to change the travel route or the charging area and time.

When the number of notices that no parking lot can be reserved reaches a prescribed number (YES in step S60), for example, the first retrieval unit 853 retrieves the parking lots 100 again (step S61) to extract a parking lot 100 (step S62). Step S62 differs from step S42 described in the fourth embodiment in that the extracted parking lot is not limited to a parking lot for which the vehicles of the company AAA are reserved.

For example, the reservation unit 854 searches the extracted parking lots 100 for a parking lot 100 corresponding to the fourth assignment priority described with reference to FIG. 11E (step S63). If there is no parking lot 100 corresponding to the fourth assignment priority (NO in step S63), for example, the reservation unit 854 issues a notice that no parking lot can be reserved and transmits it to the server 600A. Then, the server 600A changes the travel route or the charging area and time (step S64). Then, the server 600A issues a reservation request for the parking lot 100 (a request for mediation with the vehicle of another company (BBB company in this example)) together with the changed route or charging area and time, and transmits them to the server 800. The server 800 repeats the process of step S61 and its subsequent steps.

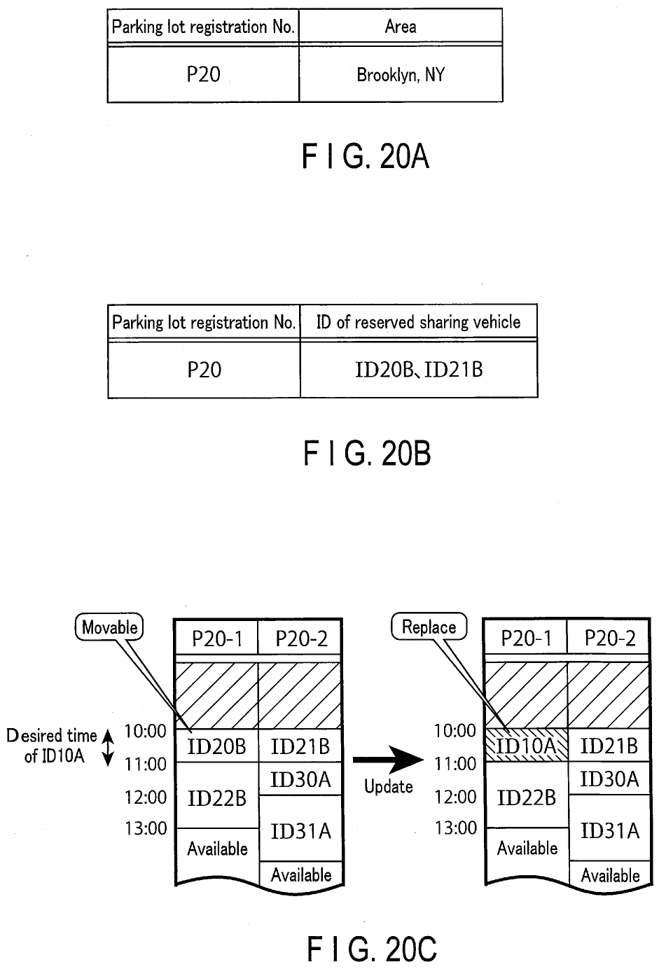

If a parking lot 100 corresponding to the fourth assignment priority is found in step S63 (YES in step S63), for example, the reservation unit 854 of the server 800 extracts information regarding the parking lot 100 from the parking lot contract information 836, and also extracts vehicle information regarding the parked vehicles 3003 from the timetable 837, for example (step S65). This extraction is shown in FIGS. 20A and 20B. In this example, the parking lot 100 whose registration number is P12 described with reference to, for example, FIG. 14 is extracted, and the vehicle ID information of the vehicles 300B under reservation is also extracted from the reservation timetable 837. Then, the fee calculation unit 856 of the server 800 calculates a parking fee required for mediation (step S66). Then, for example, the transmission/reception unit 850 of the server 800 transmits an operating schedule change request to the server 600A together with the extracted information.

Then, for example, the first retrieval unit 661 of the server 600B identifies a vehicle whose operating schedule can be changed and a parking lot for which the vehicle is reserved (step S67). That is, as shown in FIG. 20B, at least one of the extracted vehicles ID20B and ID21B and the parking lot P10 in which these vehicles are parked are selected. Assume in this example that, for example, both the vehicles ID20B and ID21B are selected. Subsequently, for example, the transmission/reception unit 660 of the server 600 transmits the information obtained in step S67 to the server 800.

In the server 800 that has received the above information, for example, the first retrieval unit 853 selects a vehicle of the company BBB having the best conditions for the company AAA as a target for mediation (step S68). As the best conditions, available parking time, costs for movement of vehicles, and the like are taken into consideration when a plurality of vehicles 300B are chosen as targets for mediation, or the size, evaluation value, parking fee, available parking time, charging capability, and the like of the parking lots 100 are taken into consideration when a plurality of vehicles 300B are parked in a plurality of parking lots 100. Assume in this example that for example, the vehicle ID20B is selected and the server 600B is notified of the selection in FIG. 20B.

The server 600B acquires the battery remaining amount information of the vehicle ID20B by the same method as in steps S11 and S12 described in the first embodiment (steps S69 and S70). Then, for example, the first retrieval unit 661 of the server 600B changes the operating schedule of the vehicle ID20B in accordance with the battery remaining amount information (step S71). For example, the travel route of the vehicle ID20B and the parking lot to be used are changed. When the change of the operating schedule is completed, the transmission/reception unit 660 transmits a change completed notice of the operating schedule to the server 800 together with the vehicle ID (vehicle ID20B in this example) of the vehicle 300B that responds to the mediation.

Upon receiving the change completed notice, the server 800 assigns the parking lot P20 reserved for the vehicle ID20B to the vehicle ID10A (step S72). Then, the server updates the reservation time table 837 (step S73). This reservation is shown in FIG. 20C. FIG. 20C is a conceptual diagram of the reservation timetable 837.

As shown in FIG. 20C, the parking space P20-1 of the parking lot P20 is reserved by the vehicle ID20B during a time period of 10:00 to 11:00 and reserved by the vehicle ID22B during a time period of 11:00 to 13:00. The other parking space P20-2 is reserved by the vehicle ID21B during a time period of 10:00 to 11:00, reserved by the vehicle ID30A during a time period of 11:00 to 12:00, and reserved by the vehicle ID31A during a time period of 12:00 to 14:00. Assume in this situation that the customer of the vehicle ID10A wishes to park it during the time period of 10:00 to 11:00. If, then, the server 600B determines that the operating schedule of the vehicle ID20B can be changed, the server 800 cancels the reservation for the vehicle ID20B during the time period of 10:00 to 11:00 for the parking space P20-1, and sets a reservation for the vehicle ID10A instead. In addition, for the vehicle ID20B for which the reservation for the parking lot P20 is canceled, another parking lot may be reserved when necessary.

After that, as in the first embodiment, the server 800 transmits reservation completed information 640 indicating that the reservation is completed and information 639 regarding the reserved parking lot to the servers 600A and 600B. Based on the received information, the server 600A determines the travel routes of the vehicle ID10A and the server 600B determines the travel route of the vehicle ID20B (steps S74 and S75). Then, the servers 600A and 600B set the determined travel routes to the vehicles ID10A and ID20B (step S76).

5.3 Advantages of Fifth Embodiment

As described above, mediation between the vehicles 300 managed by different carsharing companies can be achieved by the method according to the fifth embodiment. This method makes it possible to greatly increase the number of available parking lots and improve the degree of freedom of selecting a parking lot by the parking lot scheduling company.

Like in the fourth embodiment described with reference to FIG. 17, in the fifth embodiment, it is possible to search for parking lots 100 corresponding to the first and second assignment priorities, search for parking lots 100 corresponding to the third assignment priority, and search for parking lots 100 corresponding to the fourth assignment priority, and calculate a parking fee for each of the parking lots. Based on the calculated parking fee, a parking lot can be selected.

### 6. SIXTH EMBODIMENT

Next is a description of an information processing device, an information processing method and an information processing program according to a sixth embodiment. In the fourth and fifth embodiments described above, mediation is requested by the vehicles 300 (that is, the carsharing company). The sixth embodiment relates to a process when mediation is requested by the owners of the parking lots 100. The sixth embodiment will be described, regarding only the points different from those of the first to fifth embodiments.

### 6.1 Configuration of Smartphone 200

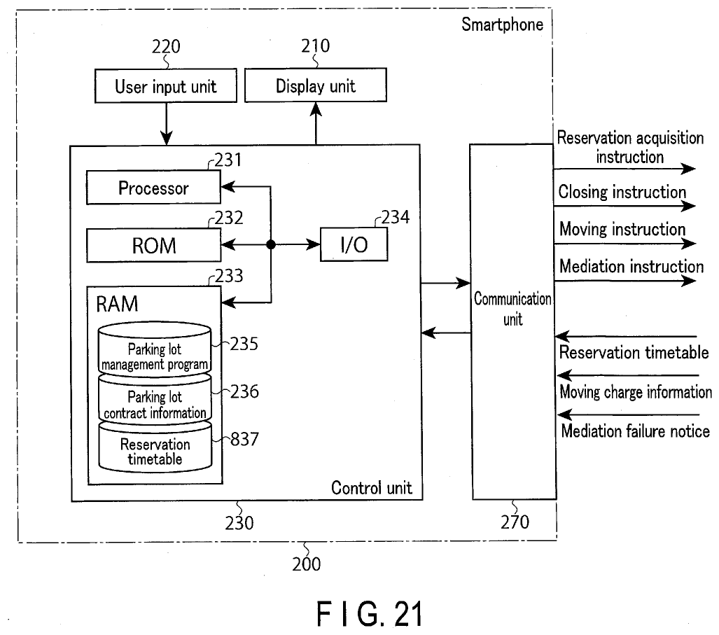

FIG. 21 is a block diagram showing an example of a configuration of a smartphone 200 according to the six embodiment. As shown in FIG. 21, like the smartphone 500, the smartphone 200 includes a display 210, a user input unit 220, a control unit 230 and a communication unit 270.

The display 210 presents various information items to a user, and it is, for example, a liquid crystal display.

The user input unit 220 receives various information items and instructions from a user. For example, the display 210 may be a touch panel display device which is integrated with the user input unit 220 as one unit.

The communication unit 270 transmits and receives information to and from the servers 600 and 800 by wireless communication.

The control unit 230 controls the process of the entire smartphone 200. The control unit 230 includes a processor 231 such as a CPU, a ROM 232, a RAM 233 and an input/output circuit 234. The ROM 232 stores programs executed by the processor 231 and necessary data. The RAM 233 functions as a work area of the processor 231. The input/output circuit 234 controls transmission and reception of information to and from the communication unit 270. The processor 231 executes programs in the ROM 232 and RAM 233. The RAM 233 stores a parking lot management program 235, parking lot contract information 236 and a reservation timetable 837.

The parking lot contract program 235 causes the smartphone 200 to perform various functions including a process necessary to use the parking lot reservation system 1 by the owner of parking lots. The processor 231 that has executed the program 235 causes, for example, the RAM 233 to store the information received by the user input unit 220. For example, the processor 231 executes the parking lot management program 235 to perform a process for allowing the parking lot scheduling company to manage the parking lots 100, as described in the first embodiment. For example, the processor 231 prompts the user to input various information items shown in FIG. 12B in the user input unit 220, transmits the information items to the server 800, and concludes a parking lot management contract between the user and the parking lot scheduling company. The information regarding the contract is the parking lot contract information 236. The processor 231 also executes the parking lot management program 235 to perform a process for mediation requested by the owner of parking lots, as described in the sixth embodiment. Then, the smartphone 200 receives the reservation timetable 837 from the server 800.

### 6.2 Mediation Method

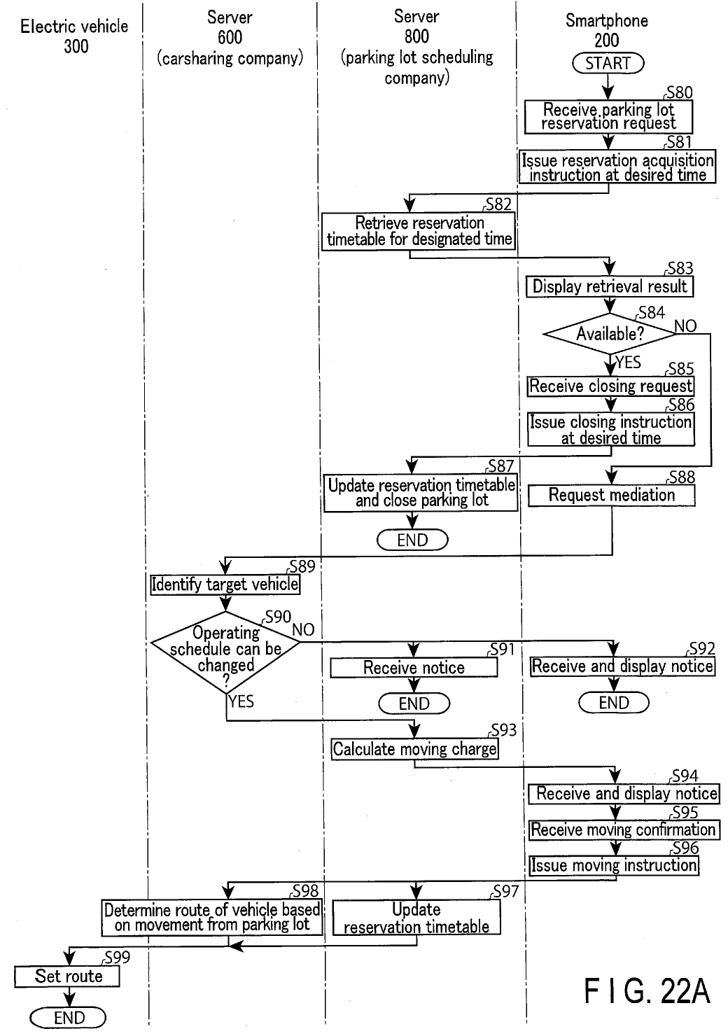

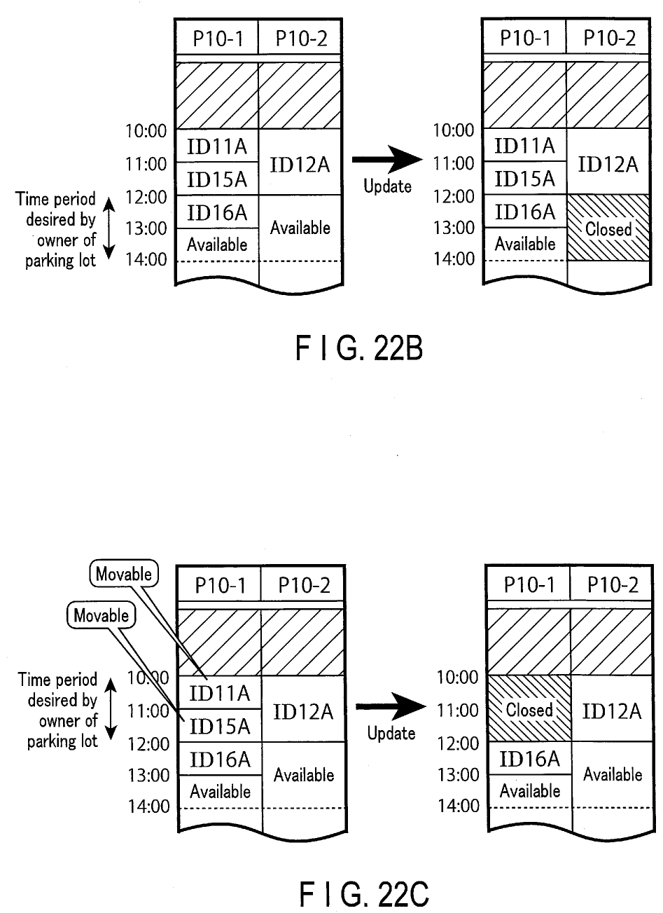

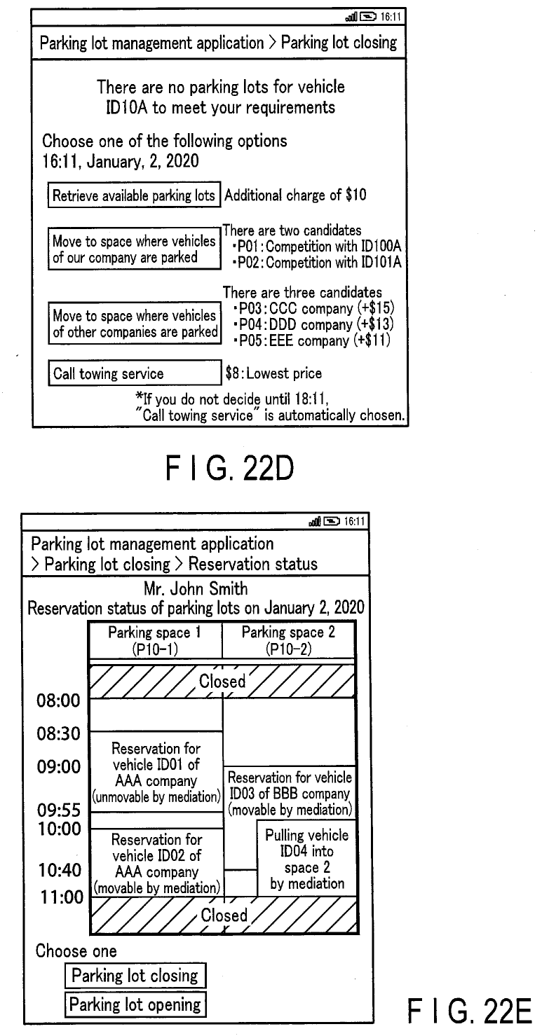

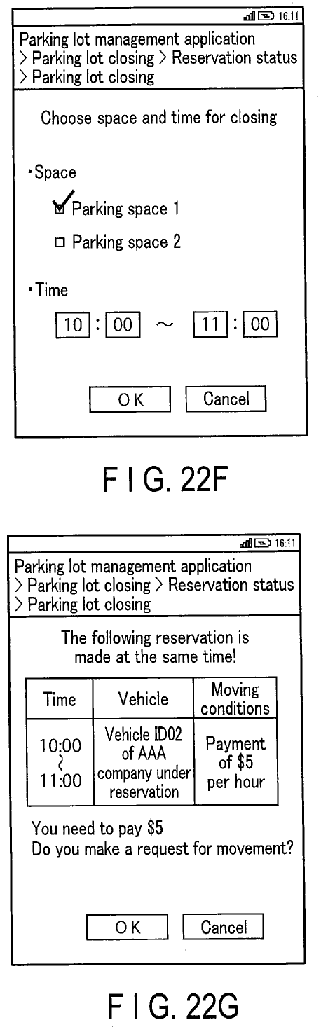

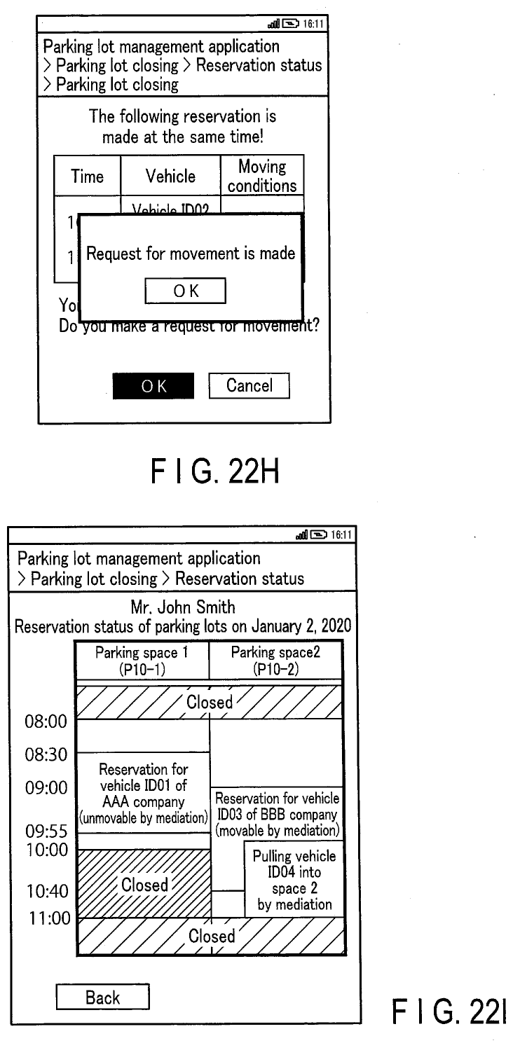

FIG. 22A is a flowchart illustrating the operations of the smartphone 200, electric vehicle 300, server 600 and server 800 performed when the owner of a parking lot 100 perform mediation to use the parking lot 100 that is full. The mediation method will be described by way of an example in which the owner of the parking lot P10 in the fourth embodiment described with reference to FIG. 14 uses the parking lot P10 when the parking lot P10 is full. The process of the smartphone 200 is performed mainly by the processor 231 (or the entire control unit 230).

As shown in FIG. 22A, the smartphone 200 of the owner of the parking lot P10 receives a reservation request of the parking lot P10 from the owner (step S80). Then, the processor 231 of the smartphone issues an instruction to acquire a schedule at the time desired by the owner and transmits it to the server 800 (step S81). The server 800 that has received the acquisition instruction retrieves the reservation timetable 837 in a time period designated by the smartphone 200, and transmits a result of the retrieval to the smartphone 200 (step S82).

The smartphone 200 that has received the reservation timetable 837 causes the display 210 to display the reservation timetable 837 (step S83). If there is an available time period desired by the owner (YES in step S84), the smartphone 200 receives a closing request from the owner (step S85). Then, the processor 231 of the smartphone 200 issues time desired by the owner and an instruction to close the parking lot P10 at the time, and transmits them to the server 800 of the parking lot scheduling company (step S86). Then, the processor 831 of the server 800 closes the parking lot P10 at the designated time in accordance with the received closing instruction (step S87). This is shown in FIG. 22B. FIG. 22B is a conceptual diagram of the reservation time table 837.

Assume that the owner of the parking lot P10 tries to make a reservation for the parking lot P10 for a time period of 12:00 to 14:00 as shown in FIG. 22B. In this example, the parking space P10-2 is available. Accordingly, the server 800 closes the parking space P10-2 for a time period of 12:00 to 14:00. Thus, only the owner of the parking lot P10 can use the parking space P10-2.

If, in step S84, there is no space in the parking lot P10, the processor 231 of the smartphone 200 requests the server 600 of the carsharing company to perform mediation (step S88). At this time, information regarding the desired parking lot P10 and time period is also transmitted to the server 600. The server 600 that has received the mediation request refers to the reservation timetable 837 to identify a vehicle to be mediated (step S89). Subsequently, the server 800 determines whether the operating schedule of the identified vehicle can be changed (step S90). The process of step S90 is similar to, for example, that of step S46 described with reference to FIG. 15 and that of step S67 described with reference to FIG. 19. If the operating schedule cannot be changed (NO in step S90), the server 600 transmits a failure in mediation to the server 800 (step S91) and further transmits it to the smartphone 200 (step S92). In the smartphone 200, the display 210 displays the failure in mediation.

On the other hand, when the operating schedule can be changed (YES in step S90), the server 600 transmits an instruction to change the operating schedule and calculate a moving charge to the server 800. In response to the instruction, the server 800 changes the operating schedule for the owner of the parking lot P10 and calculates a moving charge to be paid to the user of a vehicle moving from the parking lot P10 or the carsharing company thereof (step S93). After that, the server 800 notifies the smartphone 200 of the moving charge and also notifies it that mediation can be performed in the corresponding parking lot P10. Then, the smartphone 200 causes the display 210 to display the received information and prompts the owner to decide whether to accept the mediation (step S94).

If the smartphone 200 receives acceptance of mediation by the owner (step S95), the processor 231 issues a moving instruction and transmits it to the servers 600 and 800 (step S96). Then, the server 800 updates the reservation timetable 837 (step S97). This update is shown in FIG. 22C. FIG. 22C is a conceptual diagram of the reservation timetable 837.

Assume that the owner of the parking lot P10 tries to make a reservation for the parking lot P10 for a time period of 10:00 to 12:00 as shown in FIG. 22C. In this example, the parking space P10-1 has been reserved by the vehicles ID11A and ID15A, and the parking space P10-2 has been reserved by the vehicle ID12A. At this time, assume that the operating schedules of the vehicles ID11A and ID15A can be changed in step S90 and that the moving fee is acceptable to the owner. The smartphone 200 then issues an instruction to move the vehicles ID11A and ID15A. Then, the server 800 closes the parking space P10-1 for the time period of 10:00 to 12:00.

Furthermore, the server 600 that has received the moving instruction resets and determines a travel route to each of the vehicles ID11A and ID15A which are to move (step S98). The process of step S98 is similar to that of step S51 described with reference to FIG. 15 and those of steps S74 and S75 described with reference to FIG. 19. Then, the server 600 resets a travel route to each of the vehicles ID11A and ID15A (step S99).

### 6.3 Display Example of Smartphone 200

An example of screen display of the smartphone 200 held by the owner of parking lots during the operation described with reference to FIG. 22A will be described with reference to FIGS. 22D to 221. FIGS. 22D to 221 schematically show display screens of the display 210 of the smartphone 200.

FIG. 22D is a display screen when there is no vehicle whose operating schedule can be changed in step S90 of FIG. 22A (NO in step S90). As shown in FIG. 22D, the message “There are no parking lots for vehicle ID10A to meet your requirements” is displayed. With this message, the processor 231 notifies the owner that the vehicle ID10A cannot be parked in his own parking lot 100. The processor 231 also presents some options to the owner. In the example of FIG. 22D, the following four options are presented:

“Retrieve available parking lots” This option is to retrieve another parking lot with available space and reserve it if any. The parking fee will be $10 larger than the owner's desired fee.

“Move to space where vehicles of our company are parked”

This option is to replace vehicle ID10A managed by carsharing company AAA with another vehicle managed by the same carsharing company AAA to be parked. That is, another vehicle is requested to move by mediation. In the case of FIG. 22D, the vehicle ID100A can be moved from the parking lot P01, and the vehicle ID101A can be moved from the parking lot P02. In other words, these vehicles can be replaced with the vehicle of the owner of the parking lots.

“Move to space where vehicles of other companies are parked”

This option is to replace vehicle ID10A managed by carsharing company AAA with another vehicle managed by different carsharing company BBB to be parked. That is, the vehicle of the different company is requested to move by mediation. In the example of FIG. 22D, the vehicle can be replaced with the vehicle managed by company CCC in parking lot P03 with an additional charge of $15, it can be replaced with the vehicle managed by company DDD in parking lot P04 with an additional charge of $13, and it can be replaced with the vehicle managed by company EEE in parking lot P05 with an additional charge of $11.

“Call towing service”

This option is to tow the parked cars away. The charge is $8.

FIG. 22E shows a screen displayed on the smartphone 200 in, for example, step S80. When the smartphone 200 receives a parking lot reservation request, it receives the reservation timetable 837 of a corresponding parking lot from the server 800 and displays it on the display 210. In the example of FIG. 22E, the owner of the parking lot P10 is Mr. John. Smith, and the reservation status of two parking spaces is displayed on the display 210 of the smartphone 200. In the display 210, the closing or opening of the parking lot can be chosen by an icon.

FIG. 22F shows a screen displayed on the smartphone 200 at the execution of step S81. As shown in FIG. 22F, the smartphone 200 prompts the owner of the parking lot to enter the parking space to be closed and the time of day. The information regarding the parking space is obtained from the parking lot contract information 236 stored in the RAM 233, for example.

FIG. 22G shows a screen displayed on the smartphone 200 at the execution of step S94. As shown in FIG. 22G, when the smartphone 200 receives a moving fee from the server 600, it prompts the owner of the parking lot to determine whether to make a moving request. Upon receiving the moving request in step S95, the smartphone 200 displays a message to that effect as shown in FIG. 22H, and issues a moving instruction to the server 600. After that, when the reservation timetable 837 is updated in step S97, the updated reservation timetable 837 is transmitted to the smartphone 200, and the smartphone 200 displays a screen as shown in FIG. 22I. As shown in FIG. 22I, the parking space 1 designated in FIG. 22F is closed for a time period of 10:00 to 11:00.

### 6.4 Advantages of Sixth Embodiment

As described above, the owner of the parking lots can perform mediation by, for example, the method according to the sixth embodiment. The method makes it possible to improve the convenience of the parking lot 100 by its owner and expect that a number of owners of parking lots register the parking lots in the parking lot reservation system 1. As the number of registered parking lots increases more and more, the convenience of the reservation system 1 can be improved.

### 7. SEVENTH EMBODIMENT

Next is a description of an information processing device, an information processing method and an information processing program according to a seventh embodiment. The seventh embodiment relates to the entire flow of the third to fifth embodiments, and also relates to a towing service that is performed when mediation is impossible in the fifth embodiment. The seventh embodiment will be described, regarding only the points different from those of the first to sixth embodiments.

### 7.1 Mediation Method

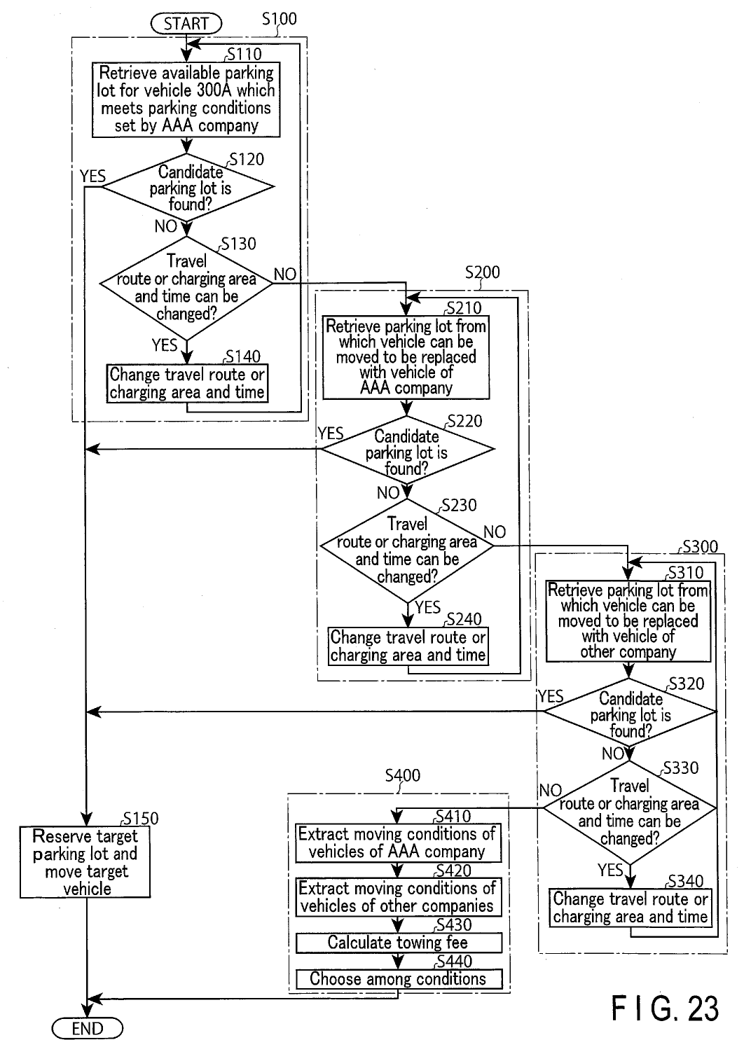

FIG. 23 is a flowchart showing an operation of a parking lot reservation system 1 according to the seventh embodiment. As shown in FIG. 23, the operation of the system 1 generally includes five steps S100, S150, S200, S300 and S400.

Step S100 corresponds to the first to third embodiments and its details are as described with reference to FIG. 13, for example. That is, when a reservation request is made for the vehicle 300A of the carsharing company AAA, the server 800 of the parking lot scheduling company retrieves an available parking lot based on priority conditions and the like (step S110). If a candidate parking lot 100 is found as a result of step S110 (YES in step S120), the server 800 reserves the parking lot 100 (step S150). If no candidate parking lot 100 is found (NO in step S120), the server 600 determines whether the travel route or charging area and time can be changed (step S130). If they can be changed (YES in step S130), they are changed (step S140), and the process returns to step S110. If they cannot be changed (NO in step S130), the process of step S200 is performed.

Step S200 corresponds to the fourth embodiment, and its details are as described with reference to FIG. 15, for example. That is, the server 800 retrieves a vehicle that can be moved from its parking lot 100 among the vehicles managed by the AAA company (step S210). If a candidate parking lot 100 is found as a result of step S210 (YES in step S220), the server 800 performs a process of reserving the parking lot 100 and moving the vehicle therefrom (step S150). If no candidate parking lot 100 is found (NO in step S220), the server 600 determines whether the travel route or charging area and time can be changed (step S230). If they can be changed (YES in step S230), they are changed (step S240), and the process returns to step S210. If they cannot be changed (NO in step S230), the process of step S300 is performed.

Step S300 corresponds to the fifth embodiment, and its details are as described with reference to FIG. 19, for example. That is, the server 800 retrieves a vehicle that can be moved from its parking lot 100 among the vehicles managed by a carsharing company other than the AAA company (step S310). If a candidate parking lot 100 is found as a result of step S310 (YES in step S320), the server 800 performs a process of reserving the parking lot 100 and moving the vehicle therefrom (step S150). If no candidate parking lot 100 is found (NO in step S320), the server 600 determines whether the travel route or charging area and time can be changed (step S330). If they can be changed (YES in step S230), they are changed (step S340), and the process returns to step S310. If they cannot be changed (NO in step S330), the process of step S400 is performed.

Step S400 is a process of continuing a mediation process or calling a towing service. That is, the server 800 of the parking lot scheduling company again retrieves a vehicle that can be moved from the parking lot 100, among the vehicles managed by the AAA company (step S410). However, unlike in step S210, a parking lot 100 that greatly deviates from the travel route of the vehicle 300A is also retrieved. Accordingly, the moving conditions for vehicles managed by the AAA company are obtained. Subsequently, the server 800 again retrieves a vehicle that can be moved from the parking lot 100, among the vehicles managed by the carsharing company other than the AAA company (step S420). However, unlike in step 310, a parking lot 100 that greatly deviates from the travel route of the vehicle 300A is also retrieved. Accordingly, the moving conditions for vehicles managed by the carsharing company other than the AAA company are obtained. In addition, the server 800 calculates the charge required for towing the parked vehicle 300 in the parking lot 100 retrieved in steps S210 and S310 (step S430). The condition and charge information is transmitted to the server 600 of the carsharing company, and the server 600 selects acceptable conditions and charge among the presented conditions and charges, and transmits them to the server 800 (step S440). At this time, the server 600 may transmit each of the conditions and the like to the smartphone 500 to request selection by the user of the vehicle 300A.

### 7.2 Advantages of Seventh Embodiment

As described above, the first to third embodiments, the fourth embodiment, and the fifth embodiment can be implemented. If no mediation can be performed even by the fifth embodiment, the user can finally select mediation without satisfying his or her desired conditions or calling of a towing service. It is thus possible to prevent the situation that the vehicle 300A cannot be parked in the parking lot 100.

### 8. EIGHTH EMBODIMENT

Next is a description of an information processing device, an information processing method and an information processing program according to an eighth embodiment. The eighth embodiment relates to a method for generating evaluation information 839 in the first to seventh embodiments. The eighth embodiment will be described, paying attention to only the points different from those of the first to seventh embodiments.

### 8.1 Evaluation Information 839

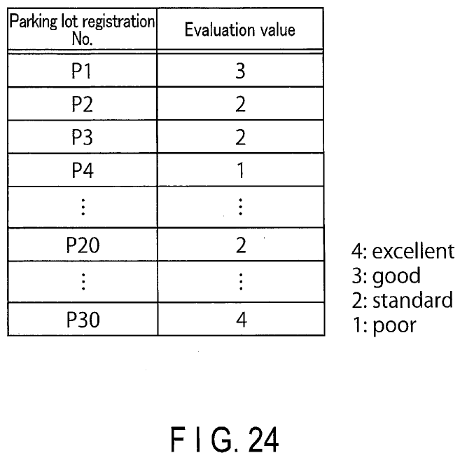

FIG. 24 is a conceptual diagram schematically showing the evaluation information 839. As shown in FIG. 24, the evaluation information 839 includes an evaluation value for each of the parking lots 100 managed by a parking lot scheduling company. In the example of FIG. 24, the evaluation value is represented by a numerical value, and evaluation becomes higher as the numerical value increases. For example, the evaluation value of parking lot P4 is “1” which indicates the lowest evaluation. The evaluation values of parking lots P2, P3 and P20 are “2” which indicates an average evaluation. The evaluation value of parking lot P1 is “3” which is a high evaluation. The evaluation value of parking lot P30 is “4” which is the highest evaluation. These evaluation values correspond to the accommodation evaluation value described with reference to FIG. 11B, for example. The method for defining the level of evaluation is not limited to that shown in FIG. 24.

### 8.2 Evaluation Method

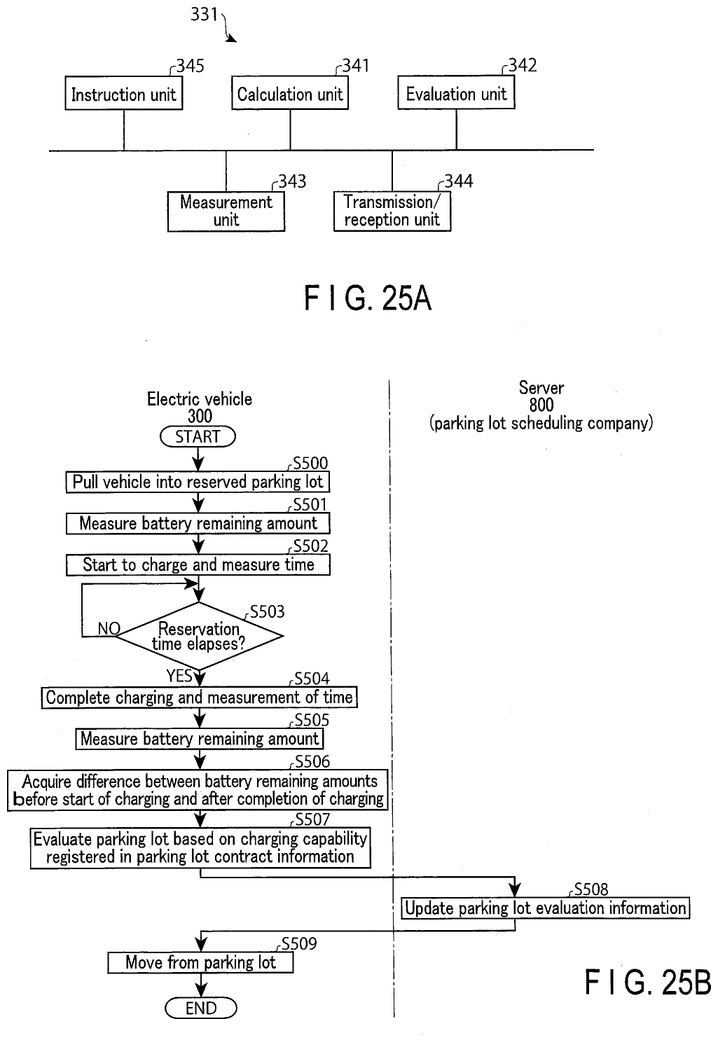

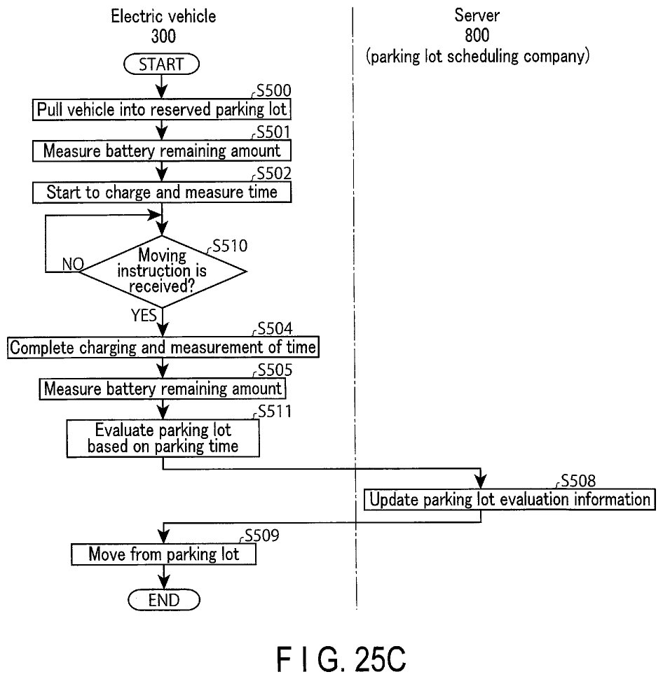

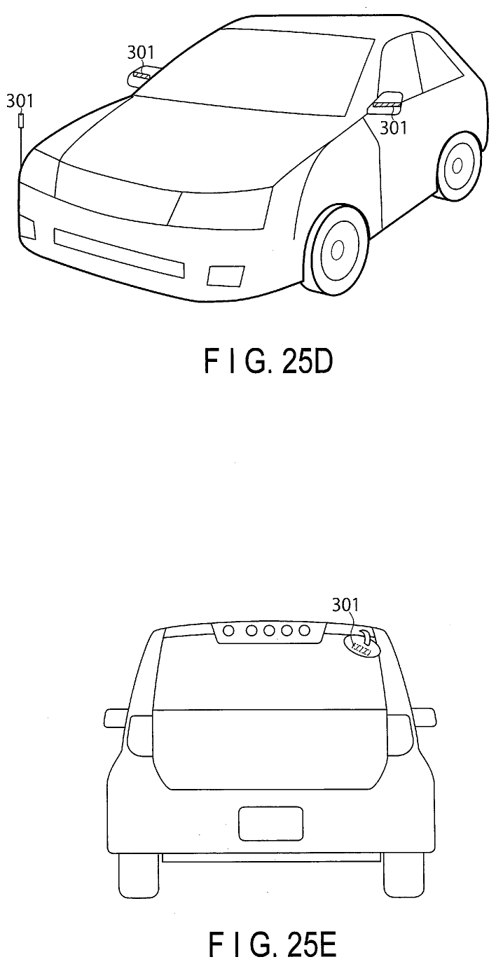

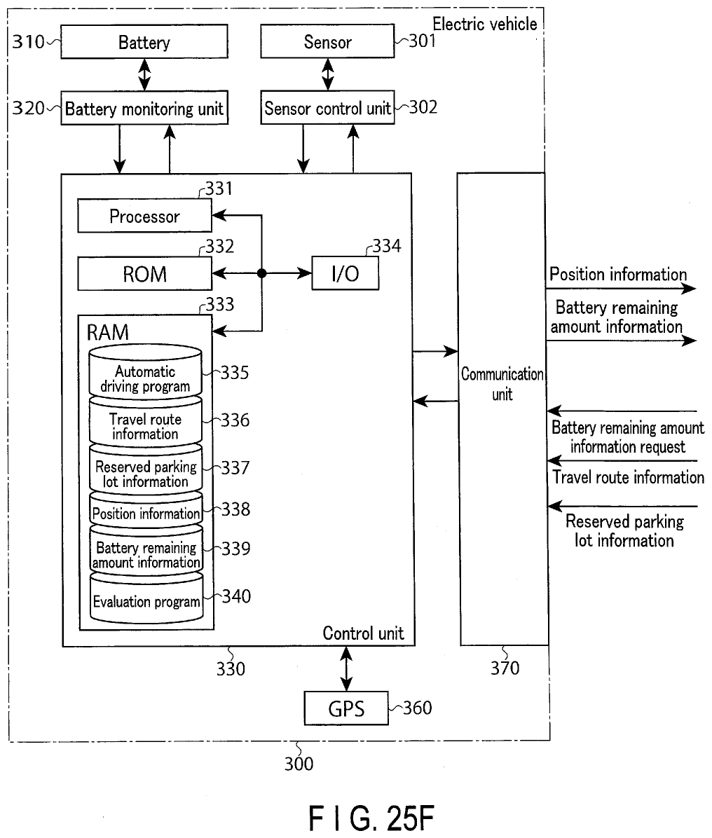

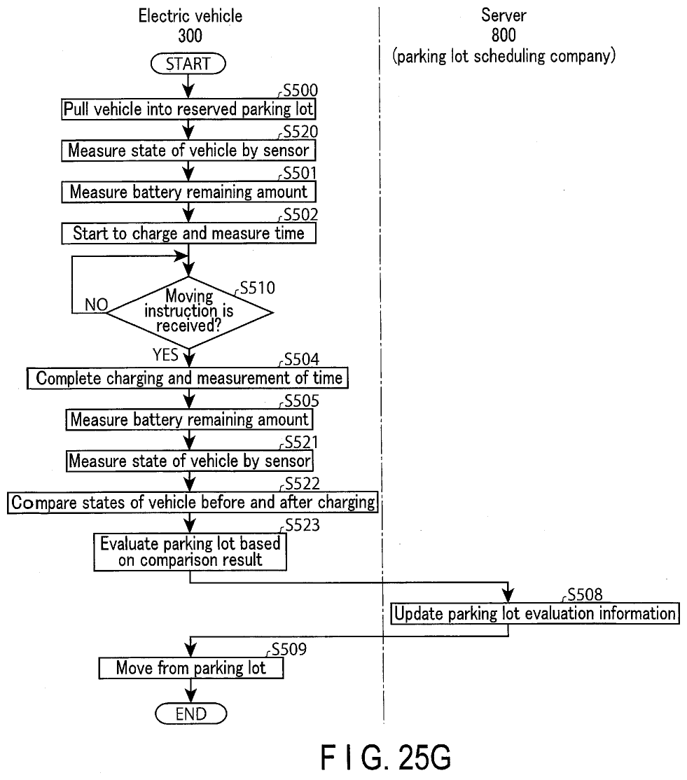

Next is a description of a method of evaluating the parking lots 100 to obtain the evaluation information 839. In the configuration of the vehicle 300 described in the first embodiment with reference to FIG. 2, the RAM 333 further includes an evaluation program 340. FIG. 25A is a functional block diagram of the processor 331 of the vehicle 300 performed while the evaluation program 340 is being executed. Note that the evaluation program 340 may be part of the automatic driving program 335.

As shown in FIG. 25A, the processor 331 functions as an instruction unit 345, a calculation unit 341, an evaluation unit 342, a measurement unit 343 and a transmission/reception unit 344. An instruction unit 345 controls the battery monitoring unit 320. The calculation unit 341 calculates a difference of the battery remaining amounts. The measurement unit 343 measures time. The evaluation unit 342 evaluates the parking lots 100 based on the results obtained by the calculation unit 341 and the measurement unit 343. The transmission/reception unit 344 transmits the evaluation value obtained by the evaluation unit 342 to the server 800.

The following is a description of three evaluation methods.

(1) First Evaluation Method

As a first evaluation method, an evaluation method according to the charging capability of the parking lot 100 will be described with reference to FIG. 25B. FIG. 25B is a flowchart of the first evaluation method.

As shown in FIG. 25B, first, the vehicle 300 pulls into the reserved parking lot 100 (step S501). Then, based on the instruction of the instruction unit 345, the battery monitoring unit 320 measures the battery remaining amount and stores it in the RAM 333, for example (step S501). Then, the charger 110 starts to charge the vehicle, and the measuring unit 343 starts to measure time (step S502). When the reservation time for the parking lot 100 elapses (step S503), the charger 110 completes the charging, and the measurement unit 343 also completes the measurement (step S504).

In response to the instruction of the instruction unit 345, the battery monitoring unit 320 measures the battery remaining amount and stores it in the RAM 333, for example (step S505). Then, the calculation unit 341 calculates a difference between the battery remaining amount measured in step S501 and the battery remaining amount measured in step S505 (step S506). Based on the result obtained in step S506, that is, the electric power with which the vehicle is actually charged during the reservation period and the charging capability included in the parking lot information 337 (corresponding to, for example, the “charging capability” of the parking lot contract information 836 described with reference to FIG. 12B), the parking lot 100 is evaluated, and a result of the evaluation is transmitted to the server 800 (step S507). For example, if the amount of power actually charged in the vehicle is higher than the charging capability included in the parking lot information 337, the processor 331 gives a good evaluation to the parking lot 100, and if the charging capability is higher than the amount of power, the processor gives a bad evaluation thereto.

Upon receiving the evaluation result from the vehicle 300, the server 800 updates the evaluation information 839 based on the received evaluation result (step S508). For example, when the evaluation unit 342 receives a certain number or more of good evaluation results, it increases the evaluation value described with reference to FIG. 24 by “1.” On the contrary, when it receives a certain number or more of bad evaluation results, it decreases the evaluation value by “1.” Then, the vehicle 300 moves from the parking lot 100 (step S509).

(2) Evaluation Method According to Parking Time in Parking Lot 100

As a second evaluation method, an evaluation method according to the parking time in a parking lot will be described with reference to FIG. 25C. FIG. 25C is a flowchart of the second evaluation method.

As shown in FIG. 25C, the processes of steps S500 to S502 described with reference to FIG. 25B are performed. Upon receiving a moving instruction from, for example, the server 600 (or the server 800) (YES in step S510), the vehicle 300 performs the processes of steps S504 and S505. Then, the calculation unit 341 calculates parking time of the vehicle 300 in the parking lot 100 based on the time measured in step S504, evaluates the parking lot 100 based on a result of the calculation, and transmits the evaluation result to the server 800 (step S511). For example, if the actual parking time is longer than the reserved parking time, the processor 331 gives a good evaluation to the parking lot 100, and if the reserved parking time is longer than the actual parking time, the processor 331 gives a bad evaluation thereto. After that, the processes of steps S508 and S509 described with reference to FIG. 25B are performed.

(3) Evaluation Method according to Troubles in Parking Lot 100

As a third evaluation method, an evaluation method according to troubles in the parking lot 100 will be described. FIGS. 25D and 25E are external views of the vehicle 300 according to the eighth embodiment when viewed obliquely from the front and when viewed from the rear. As shown in FIGS. 25D and 25E, a sensor 301 is provided at each of the side mirrors, at the corner pole, and/or at the interior of the rear under mirror. The sensor 301 is, for example, a camera with a capability of imaging for 360 degree, or a 360-degree camera. FIG. 25F is a block diagram of the vehicle 300 according to the eighth embodiment, and corresponds to FIG. 2 described in the first embodiment. As shown in FIG. 25F, the vehicle 300 includes a sensor 301 and a sensor control unit 302 in the configuration described with reference to FIG. 2. Then, the sensor control unit 302 controls the sensor 301 in response to, for example, an instruction from the processor 331 of the control unit 330.

FIG. 25G is a flowchart of the third evaluation method. As shown in FIG. 25G, when the vehicle 300 pulls into the parking lot 100 (step S500), the sensor 301 measures the state of the vehicle 300 (step S520). That is, for example, the sensor 301 images the appearance of the vehicle 300. After that, when the vehicle 300 receives a pull-out instruction (YES in step S510), the sensor 301 measures the state of the vehicle 300 again (step S521). That is, for example, the sensor 301 images the appearance of the vehicle 300. Then, the calculation unit 341 compares the measurement result obtained in step S520 with the measurement result obtained in step S521 to evaluate the parking lot 100 based on a result of the comparison (step S523). For example, the calculation unit 341 compares images taken before and after charging to detect a dent in the body of the vehicle 300. If damage such as a dent and a scratch, dirt and the like are found, the evaluation unit 342 gives a bad evaluation to the parking lot. If not, it gives a good evaluation thereto. After that, the evaluation result is transmitted to the server 800, and the evaluation information 839 is updated (step S508).

### 8.3 Advantages of Eighth Embodiment

As described above, according to the eighth embodiment, the parking lots 100 can automatically be evaluated by the vehicle 300. That is, the user of the vehicle 300 need not be aware of the evaluation of the parking lots 100, with the result that the user can be improved in its convenience.

### 9. NINTH EMBODIMENT

Next is a description of an information processing device, an information processing method and an information processing program according to a ninth embodiment. The ninth embodiment relates to a fee calculation method described in the second embodiment. This method will be described in more detail with specific examples. The ninth embodiment can thus be applied to the first and third to eighth embodiments. The ninth embodiment will be described below, regarding only the points different from those of the first to eighth embodiments.

### 9.1 Specific Examples

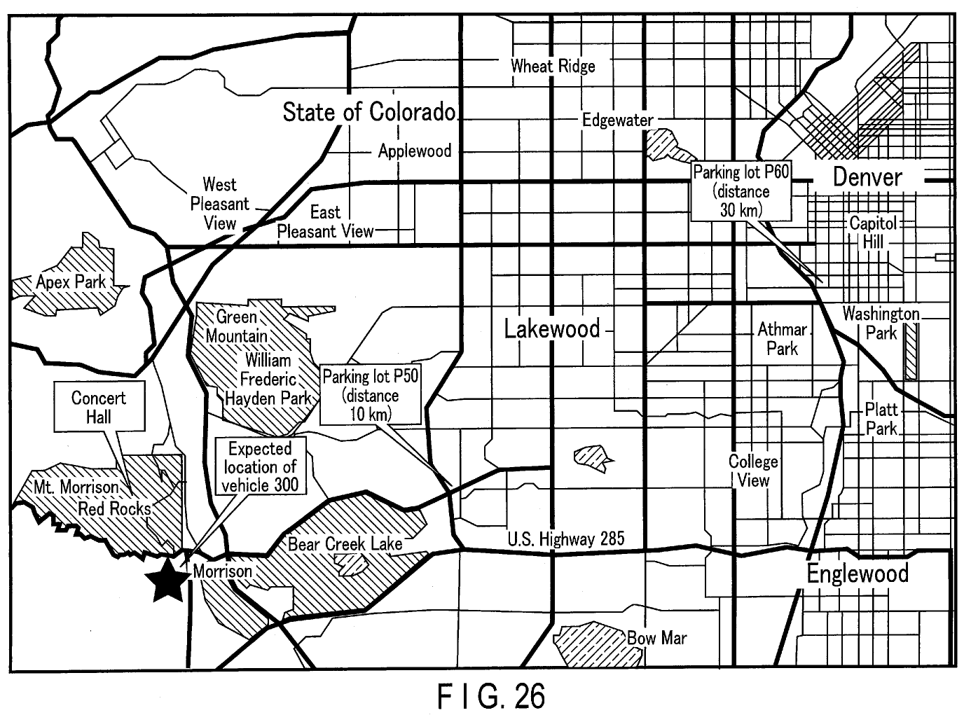

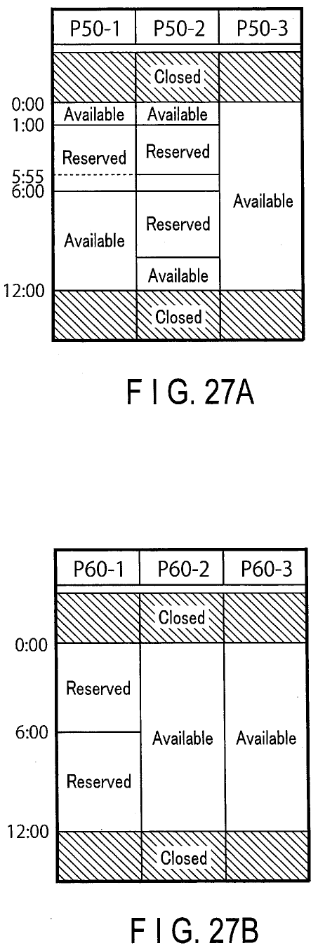

The ninth embodiment will be described with specific examples in order to facilitate understanding thereof. FIG. 26 is a map showing, in the form of a model, two parking lots P50 and P60 found in the vicinity of an event venue. FIGS. 27A and 27B respectively show reservation timetables 837 of the found two parking lots P50 and P60.

The map of FIG. 26 shows part of the State of Colorado. Assume that a concert event is held in Red Rocks, Colorado as described below.

(1) The vehicle 300 searches for available parking lots that can be used during the period of 05:40 to 05:50 at 00:00 on Feb. 20, 2020. The expected location of the vehicle 300 at 00:00 is near Morrison, Jefferson County, Colorado.

(2) Available Parking Lot P50

Location: Lakewood, Jefferson County, Colorado

Distance: Approximately 10 km from the expected location of the vehicle 300

Reservation status: Of three parking spaces, one space P50-3 can be reserved as shown in FIG. 27A.

(3) Available Parking Lot P60

Location: Denver, Colo.

Distance: Approximately 30 km from the expected location of the vehicle 300

Reservation status: Of three parking spaces, two spaces P60-2 and P60-3 can be reserved as shown in FIG. 27B.

### 9.2 Parking Fee Calculation Method

Next is a description of a method for calculating a parking fee. Assume that the rate information 841 of the parking lot P50 is as that of the second embodiment described with reference to FIGS. 8A to 8D.

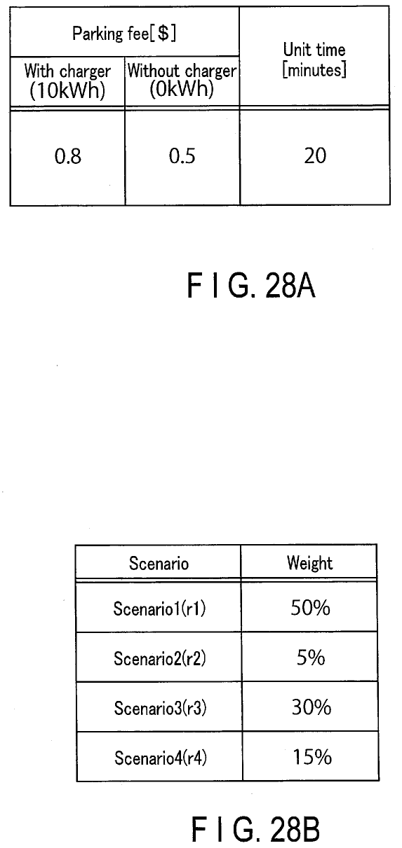

Assume that the basic parking fee of the parking lot P50 is as shown in FIG. 28A. FIG. 28A is a conceptual view of part of the parking lot contract information 836, and shows, for example, information regarding a parking fee in the information 836 described with reference to FIG. 12B. As shown in FIG. 28, the parking fee of the parking lot P50 is 80 cents when a charger is used and 50 cents when it is not used, with a unit time of 20 minutes. The charging capability of the charger is 10 kWh. The rate information 841 according to the ninth embodiment includes a scenario weight table. FIG. 28B is a conceptual diagram of the scenario weight table. The scenario weight table is information regarding weights given to four scenarios in the rate information 841 of the parking lot P50. For example, in the example of FIG. 28B, the weight given to a first scenario (shown in FIG. 8A) is 50%, the weight given to a second scenario (shown in FIG. 8B) is 5%, the weight given to a third scenario (shown in FIG. 8C) is 30%, and the weight given to a fourth scenario (shown in FIG. 8D) is 15%. That is, in calculating the parking fee of the parking lot P50, the number of remaining available spaces shown in FIG. 8A is given the most importance, and the availability status of the surrounding parking lots shown in FIG. 8B is not given much importance.

Next is a description of the rate information 841 of the parking lot P60. The rate information of the parking lot P60 also includes the price rates r1 to r4 in the first to fourth scenarios similarly to the parking lot P50.

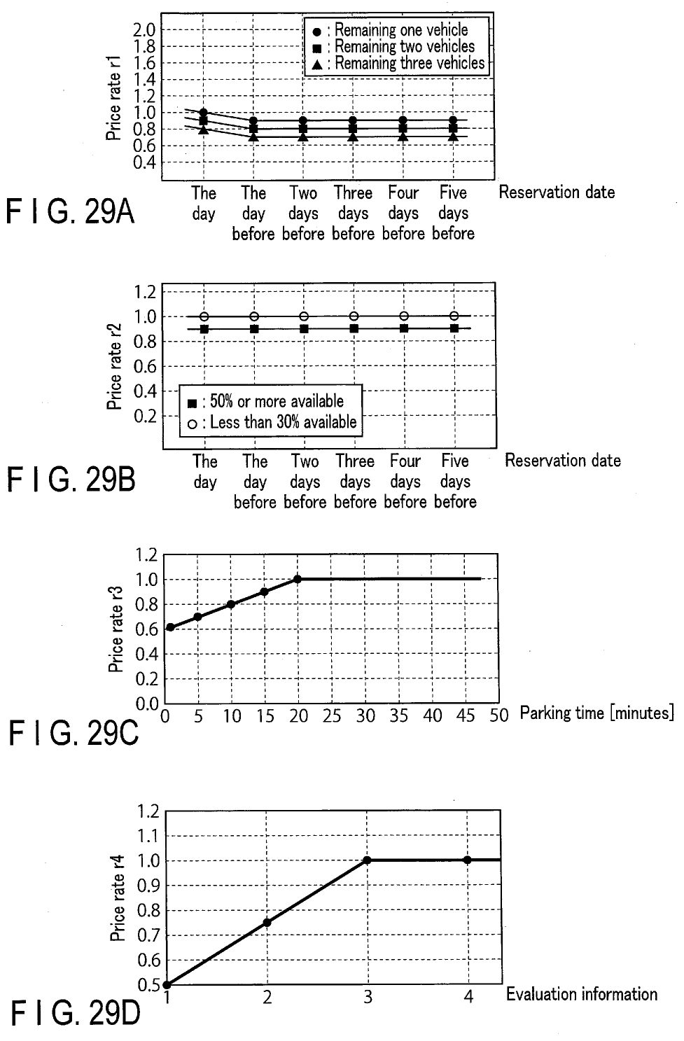

FIG. 29A shows the first scenario. As shown in FIG. 29A, when the reservation date is the same as the date of use of the parking lot, the price rate r1 is 1.0 if the number of available parking spaces is one, it is 0.9 if the number is two, and it is 0.8 if the number is three. If the reservation date is the same day, the parking fee is higher, but it does not change from the day before through five days before. FIG. 29B shows the second scenario. As shown in FIG. 29B, the price rate r2 is constant regardless of the reservation date. The smaller the number of available parking spaces in the surrounding parking lots, the higher the price rate r2. For example, the price rate r2 is 0.9 if 50% or more of the parking spaces in the surrounding parking lots are available, and it is 1.0 if it is less than 30% thereof are available. FIG. 29C shows the third scenario. As in the example of FIG. 8C, the price rate r3 decreases as the parking time becomes shorter. FIG. 29D shows the fourth scenario. In this scenario, too, the price rate r4 increases as the evaluation value becomes larger. If, however, the evaluation value is 3 or more, the price rate r4 is constant at 1.0.

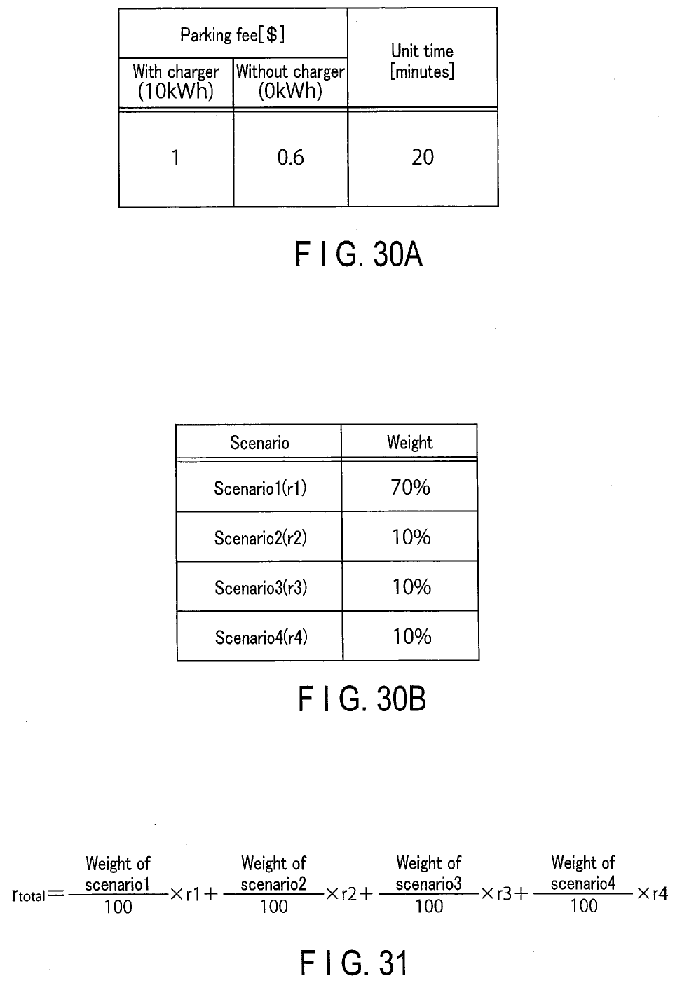

Also, assume that the basic parking fee of the parking lot P60 is as shown in FIG. 30A. FIG. 30A is a conceptual diagram of part of the parking lot contract information 836, and corresponds to FIG. 28A showing the parking fee of the parking lot P50. As shown in FIG. 30A, the parking fee of the parking lot P50 is $1 when the charger is used and 60 cents when it is not used, with a unit time of 20 minutes. The charging capability of the charger is 10 kWh. Assume that the scenario weight table for the parking lot P60 is as shown in FIG. 30B. FIG. 30B is a conceptual diagram of the scenario weight table, and corresponds to FIG. 28B showing the parking lot P50. In FIG. 30B, the weight given to a first scenario (shown in FIG. 29A) is 70%, and the weight given to each of second to fourth scenarios (shown in FIGS. 29B to 29D) is 10%.

For example, the rate selection unit 855 of the processor 831 of the server 800 uses the rate information 841 and parking lot contract information 836 to calculate a final price rate rtotal to be used. The rate selection unit 855 calculates the price rate rtotal using, for example, the equation shown in FIG. 31. The fee calculation unit 856 calculates a parking fee using the calculated price rate rtotal. In the following case, a reservation is made on the day of February 2 and a charger is used.

<Parking Fee of Parking Lot P50>

First is a description of a parking fee of the parking lot P50. Assume that the evaluation value of the parking lot P50 is “3.” In FIGS. 8A through 8D, “reservation date is equal to the same day,” “availability of surrounding parking lot (parking lot P60) is equal to 67%,” “parking time is equal to 10 minutes” and “evaluation value is equal to “3.” Thus, the price rates in the first to fourth scenarios are as follows.

r1=2.0

r2=0.9

r3=0.5

r4=1.0

Substituting the above values and the weights of the price rates r1 to r4 described with reference to FIG. 28D into the equation shown in FIG. 31, the final price rate is derived as follows.

rtotal=1.345

If, therefore, the standard fee shown in FIG. 28A is multiplied by rtoral, the parking fee of the parking lot P50 is calculated as follows.

Parking fee of P50=0.8*1.345=1 dollar and 8 cents.

<Parking Fee of Parking Lot P60>

Next is a description of a parking fee of the parking lot P60. Assume that the evaluation value of the parking lot P60 is “4.” In FIGS. 29A through 29D, “reservation date is equal to the same day,” “availability of surrounding parking lot (parking lot P50) is equal to 33%,” “parking time is equal to 10 minutes” and “evaluation value is equal to “4.” Thus, the price rates in the first to fourth scenarios are as follows.

r1=1.0

r2=0.9

r3=0.8

r4=1.0

Substituting the above values and the weights of the price rates r1 to r4 described with reference to FIG. 30B into the equation shown in FIG. 31, the final price rate is derived as follows.

rtotal=0.97

If, therefore, the standard fee shown in FIG. 30A is multiplied by rtoral, the parking fee of the parking lot P60 is calculated as follows.

Parking fee of P60=1*0.97=97 cents.

<Choice of Parking Lots>

As described above, the server 800 calculates a parking fee for each of the parking lots P50 and P60. The parking fee of the parking lot P50 is 1 dollar and 8 cents, and the parking fee of the parking lot P60 is 97 cents. Accordingly, the server 800 reserves the parking lot P60.

### 9.2 Advantages of Ninth Embodiment

As described above, according to the ninth embodiment, a parking fee can be set more appropriately by weighting a scenario to be assumed. Further, a parking fee can be set much more appropriately and a user can be prompted to use a parking lot positively by freely setting the weight (importance) appropriately by the owner of the parking lot (or a parking lot scheduling company), for example, by setting the weight to vary between a normal case and a case where an event is held in the neighborhood, with the result that the parking lot 100 can be improved in its use efficiency.

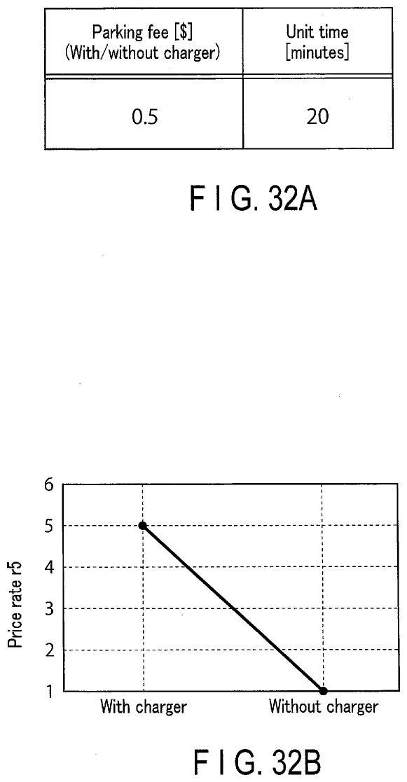

In the example of the ninth embodiment, as described with reference to FIGS. 28A and 30A, the standard fee varies between a case where a charger is used and a case where no charger is used (or between a parking lot with a charger and a parking lot without a charger). This condition may be included in the rate information 841. FIG. 32A shows parking lot contract information 836 and rate information 841 in such a case. FIG. 32A corresponds to FIGS. 28A and 30A in the foregoing embodiment and shows only information regarding parking fees in particular in the parking lot contract information 836. As shown in FIG. 32A, the parking fee is uniformly set at 50 cents per 20 minutes in both the cases with and without a charger. Instead, in the rate information 841, as shown in FIG. 32B as the fifth scenario, the weight varies between the cases with and without a charger. As shown in FIG. 32B, in the case where a charger is used, the weight is five times that in the case where no charger is used, and accordingly the parking fee is set higher. Various parameters for determining a parking fee can thus be varied by changing weight as the rate information 841 instead of setting the weight to a fixed value in the parking lot contract information 836.

In the example described above, the weights of the respective scenarios are different. However, the scenarios may be weighted uniformly. For example, when there are four scenarios, the weight of each of the scenarios may be set at 25%.

### 10. TENTH EMBODIMENT

Next is a description of an information processing device, an information processing method and an information processing program according to a tenth embodiment. The tenth embodiment relates to the parking fee calculation method described in the second, third and ninth embodiments, in which the parking fee is calculated in consideration of electricity consumption efficiency to a parking lot. The tenth embodiment will be described, paying attention to only the points different from those of the first to ninth embodiments.

### 10.1 Configuration of Server 800

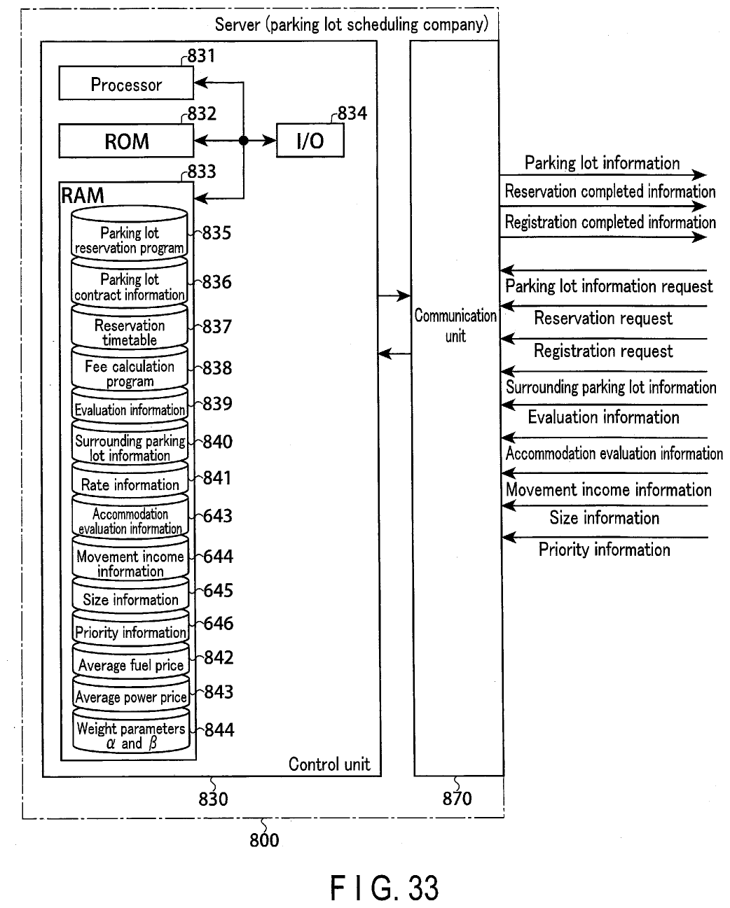

FIG. 33 is a block diagram of a server 800 of a parking lot scheduling company according to the tenth embodiment. As shown in FIG. 33, the RAM 833 of the server 800 further stores average power price information 842, average fuel price information 843 and a weight parameter 844 in the configuration described with reference to FIG. 12A.

The average power price information 843 indicates an average price of power sold by the charger 110. The price may be, for example, an average of power for the entire charging area (steps S14, S44 and S64) designated by the server 600, the average of power charges for part of the charging area, or the average of a domestic, state or local area.

The average fuel price information 842 indicates, for example, an average price of gasoline and light oil sold at gas stations. This price may also be, for example, an average fuel price for the entire area specified by the server 600, that for part of the area, or that for a domestic, state or local area.

The weight parameter information 844 includes coefficients α and β. The coefficient α is a contribution rate of power consumption from the present location to the parking lot, and is a constant that is larger than zero, for example. The coefficient β is a constant indicating an addition to the standard price of the parking lot, and includes zero, for example. The coefficients α and β can be set appropriately by the parking lot scheduling company or the owner of the parking lot.

### 10.2 Parking Fee Calculation Method

Next is a description of a parking fee calculation method according to the tenth embodiment. This parking fee calculation method will be described below, taking the case of calculating the parking fees of the parking lots P50 and P60 described in the ninth embodiment, as an example. However, assume that the charging capability of the charger of the parking lot P50 is 4 kWh and the charging capability of the charger of the parking lot P60 is 1 kWh.

For example, the fee calculation unit 856 of the processor 831 calculates a parking fee using, for example, the following equation.

Parking Fee=(Parking Fee Obtained in Ninth Embodiment)×((Power Consumption to Parking Lot/Power Supply)×α+β)

The parking lots P50 and P60 have the following conditions.

### Parking Lot P50

Distance from the present or specified location of vehicle 100: 10 km

Charging power: 4 kWh

### Parking Lot P60

Distance from the present or specified location of vehicle 100: 30 km

Charging power: 1 kWh.

If the average electricity consumption efficiency of the vehicle 100 is 10 km/kWh, the status of the vehicle 100 when it arrives at each of the parking lots P50 and P60 is as follows.

Power consumption to parking lot P50: 1 kWh

Power consumption to parking lot P60: 3 kWh

If α=1 and β=0, the parking fees of the parking lots P50 and P60 are calculated as follows.

Parking lot P50: $1.08×(1 kWh/4 kWh)=$0.27

Parking lot P60: $0.97×(3 kWh/1 kWh)=$2.91

If the amount including the electric power required to arrive at the parking lots (which is almost synonymous with a fee for charging in the parking lots) is determined as a parking fee as described above, the parking fee for the parking lot P50 is cheaper than that for the parking lot P 60 contrary to the example described in the ninth embodiment. Accordingly, the reservation unit 854 reserves the parking lot P50.

### 10.3 Advantages of Tenth Embodiment

The method according to the tenth embodiment makes it possible to calculate not only a fee for parking the vehicle 300 in the parking lot 100 but also a parking fee including the amount necessary for charging the vehicle at the parking lot 100. The server 800 of the parking lot scheduling company can thus select a parking lot more appropriately. A selected one of the method described in the ninth embodiment and the method described in the tenth embodiment can be used depending on the contract contents of the parking lot 100 or the special contract between the carsharing company and the parking lot scheduling company or the owner of the parking lot.

The foregoing embodiment has been described on the assumption that the battery 310 is charged at the parking lot 100. However, there may be a case where the battery is not charged or the parking lot 100 is provided with no charger and, in this case, the parking fee can be calculated using the following equation, for example.

Parking Fee=(Parking Fee Obtained in Ninth Embodiment)×(Power Consumption to Parking Lot×Average Power Price)×α)

Note that the average power price can be obtained from the average power price information 843.

In the tenth embodiment, the vehicle 300 can be applied not only an electric vehicle but also a gasoline vehicle and a diesel vehicle using a fuel such as gasoline or light oil (hereinafter, a vehicle which obtains driving force by burning a fuel such as fossil fuel in an engine will be called a fuel driven vehicle) and, in this case, the parking fee can be calculated using the following equation, for example.

Parking Fee=(Parking Fee Obtained in Ninth Embodiment)×(Fuel Consumption to Parking Lot×Average Fuel Price)×α)

Note that the average fuel price can be obtained from the average fuel price information 842.

### 11. ELEVENTH EMBODIMENT

Next is a description of an information processing device, an information processing method and an information processing program according to an eleventh embodiment. In the eleventh embodiment, the parking lot reservation system 1 described in the first to tenth embodiments is applied to a fuel driven vehicle such as a gasoline vehicle and a diesel vehicle. The eleventh embodiment will be described, paying attention to the method of assigning the vehicles to the parking lots 100 described in the third embodiment. The following description is directed to only points different from those of the first to tenth embodiments.

### 11.1 Parking Lot Contract Information 836

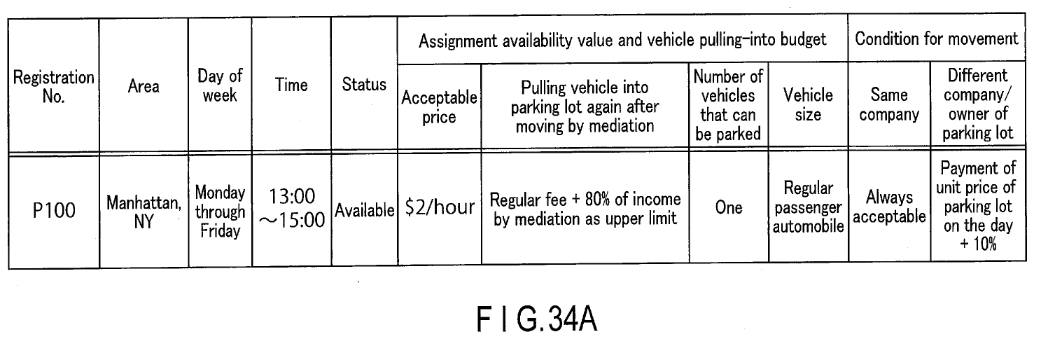

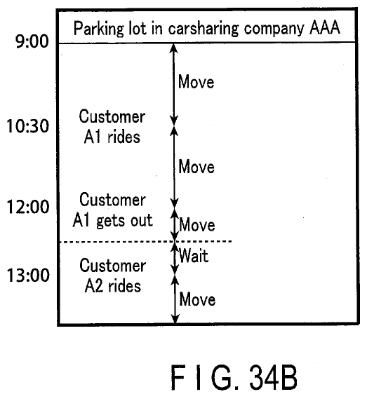

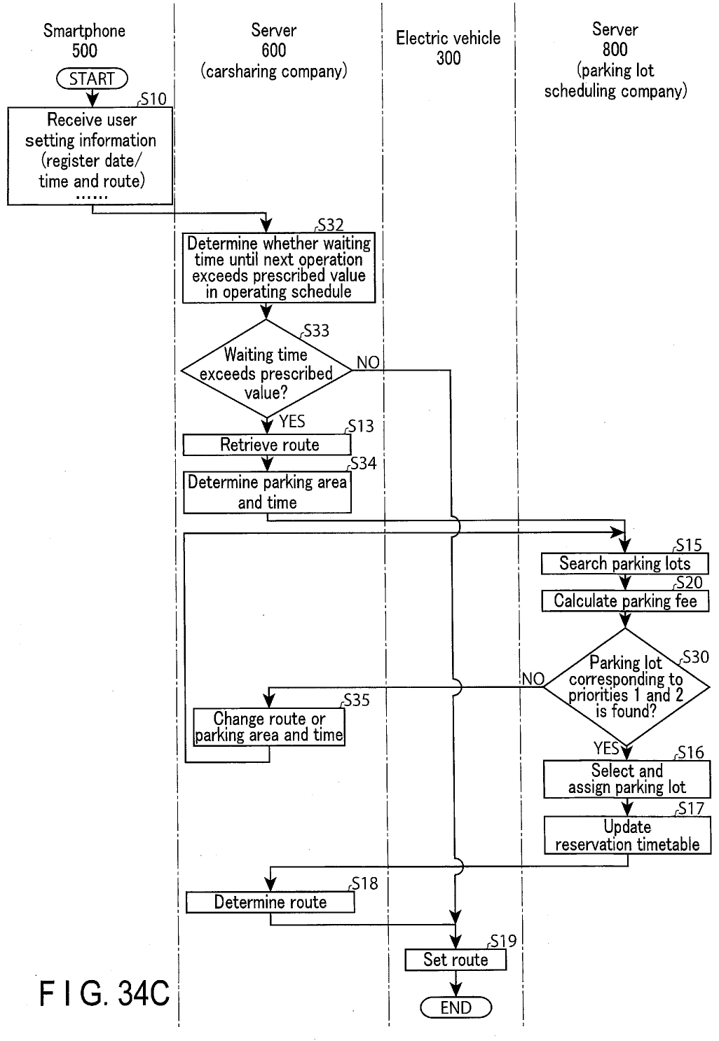

FIG. 34A is a conceptual diagram of parking lot contract information 836 according to the eleventh embodiment, and corresponds to FIG. 12B of the third embodiment, and shows an example of a parking lot P100 for a fuel driven vehicle.

As shown in FIG. 34A, the parking lot contract information 836 does not include information regarding charging of the battery 310 in FIG. 12B of the third embodiment. That is, in terms of parking fees and moving conditions, information regarding the charging remaining amount is excluded and information regarding the charging capability is also removed.

### 11.2 Operation

An example of the operation of the parking lot reservation system 1 according to the eleventh embodiment will be described with reference to FIG. 34B. FIG. 34B is a conceptual diagram of a vehicle information database 642 regarding fuel driven vehicles of the carsharing company AAA.

As shown in FIG. 34B, the following is assumed. A fuel driven vehicle leaves a carsharing company parking lot at 09:00. A customer A1 is picked up at 10:30 to his or her destination. The customer A1 gets out of the vehicle at 12:00. The vehicle moves to a predetermined location and waits there. A customer A2 is picked up at 13:00 to his or her destination. If necessary, the carsharing company AAA searches for a parking lot to use with timing when the fuel driven vehicle moves and waits after the customer A1 gets out of the vehicle.

As described with reference to FIG. 4B of the first embodiment, the vehicle information database 642 may represent information for each vehicle ID at a certain time.

FIG. 34C is a flowchart showing an operation of the parking lot reservation system 1 according to the eleventh embodiment, and corresponds to FIG. 13 described in the third embodiment. The case of mediation will be described briefly in the twelfth embodiment.

As shown in FIG. 34C, upon receiving user setting information (step S10), the server 800 determines whether waiting time until the next operation exceeds a prescribed value in the operating schedule (step S32). The process in step S32 is performed by, for example, the first determination unit 663 described with reference to FIG. 4C. The operating schedule is the information described above with reference to FIG. 34B, and the waiting time is a time period in which a fuel driven vehicle does not travel, which occurs during a period from when the customer A1 gets out of the vehicle and until when the customer A2 gets on the vehicle in FIG. 34B. In addition, the prescribed value is stored in the RAM 633 of the server 600, for example.

As a result of step S32, if the waiting time exceeds the prescribed value (YES in step S33), that is, if the fuel driven vehicle needs to wait for a certain length of time, the server 600 determines to park the fuel driven vehicle in a nearby parking lot 100. Accordingly, the server 600 searches for a travel route to the parking lot 100 close to the waiting location (step S13), and determines a parking area and parking time (step S34).

After that, the server 800 performs the processes of steps S15 and S20. If a parking lot 100 corresponding to the first or second priority is found in step S30 (YES in step S30), the server 800 performs the processes of steps S16 and S17. The travel route is thus determined (step S18), and the determined travel route is set to the fuel driven vehicle (step S19). If the parking lot 100 is not found in step S30 (NO in step S30), the server 600 changes the travel route or changes the parking area and time (step S35). Steps S34 and S35 correspond to their respective steps S14 and S31 shown in FIG. 13.

If, in step S33, the waiting time does not exceed the prescribed value (NO in step S33), a route to the destination is set without searching the parking lot 100 in particular (step S19).

### 11.3 Advantages of Eleventh Embodiment

As described above, the parking lot assignment method described in the first to third embodiments can also be applied to a fuel driven vehicle that is driven by an engine burning fossil fuel. It can also be applied to an electric vehicle which requires no charging (such as an electric vehicle which is almost fully charged or which includes a high-capacity secondary battery and a fuel cell and requires no charging while driving).

### 12. TWELFTH EMBODIMENT

Next is a description of an information processing device, an information processing method and an information processing program according to a twelfth embodiment. Like in the eleventh embodiment, in the twelfth embodiment, the parking lot reservation system 1 described in the first to tenth embodiments is applied to a fuel driven vehicle. The twelfth embodiment will be described, paying attention to the mediation method for the parking lots 100 described in the fourth to sixth embodiments. The following description is directed to only points different from those of the first to tenth embodiments.

### 12.1. Mediation Method

The mediation method for fuel driven vehicles is basically the same as the method described in the fourth to sixth embodiments, and corresponds to the method described in the flowcharts shown in FIGS. 15, 19 and 22A, from which the processes regarding the battery remaining amount and charging are removed. In the case of the fuel driven vehicles, a battery need not be charged; thus, a parking lot 100 without a charger can also be a candidate.

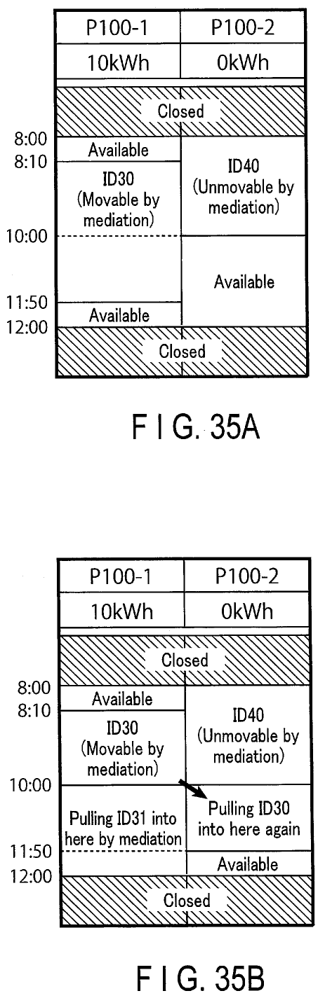

Assume in the situation shown in FIG. 35A that the customer of an electric vehicle ID31 wishes to park the vehicle between 10:00 and 12:00, as an example. As shown in FIG. 35A, the parking lot P100 has parking spaces P100-1 and P100-2 for two vehicles, but the parking space P100-2 has no charger. Then, assume that the customer of a fuel driven vehicle ID30 has reserved the parking space P100-1 having a charger for a period of 08:10 to 11:50 and the vehicle ID 30 can be moved by mediation.

Since the fuel driven vehicle ID30 need not be charged, it can be parked in the parking space P100-2. Upon receiving a request of pulling the electric vehicle ID31 into the parking space P100-2, the server 800 causes the fuel driven vehicle ID30 to move from the parking space P100-1 at 10:00 by mediation and causes it to be pulled into the parking space P100-2 again for a period of 10:00 to 11:50. The server 800 thus causes the electric vehicle ID31 to be pulled into the available parking space P100-1 by mediation.

### 12.2 Advantages of Twelfth Embodiment

As described above, the parking lot mediation method described in the fourth to sixth embodiments can be applied to a fuel driven vehicle and an electric vehicle which need not be charged. Like in the eleventh embodiment, the fuel driven vehicle requires no charger 100; thus, the degree of freedom of mediation can be improved.

### 13. MODIFICATION, ETC.

As described above, the information processing device according to each of the foregoing embodiments is an information processing device 600 to reserve a parking lot for a vehicle. The information processing device 600 includes a reception unit 660 which receives first information regarding a destination of the vehicle, a first retrieval unit 661 which retrieves a route to the destination based on the first information, a second retrieval unit 662 which retrieves a route to the destination, a first area around the route, and first time, and a reservation unit 664 which requests a reservation for a first parking lot in the first area at the first time using one of wireless communication and wired communication without waiting for an instruction from a user.

The information processing device according to each of the foregoing embodiments is also an information processing device 800 to manage a parking lot for a vehicle. The information processing device 800 includes a first retrieval unit 853 which retrieves a first parking lot based on a reservation request for a parking lot, the reservation request transmitted by one of wireless communication and wired communication, a calculation unit 856 which calculates a parking fee of the first parking lot retrieved by the first retrieval unit, and a reservation unit 854 which assigns a vehicle corresponding to the reservation request to the first parking lot.

The above configurations makes it possible to promote the effective use of parking lots. Note that each of the foregoing embodiments are nothing but one example, and various modifications thereto can be made. For example, the above embodiments are described with an example in which the vehicle 300 is an electric vehicle. As in the eleventh and twelfth embodiments, however, the vehicle 300 may be a fuel driven vehicle or a hybrid vehicle using both an internal combustion engine using fossil fuel and an electric motor.

Various programs (automatic driving program 335, carsharing program 535, route retrieval program 635, parking lot reservation program 835, etc.) in the configurations described in the foregoing embodiments can be distributed by the server of an operator who provides the reservation system 1 through a communication line such as an Internet connection. The processes to be performed by executing the respective programs have been described with reference to various flowcharts, but the order of the processes can be replaced as much as possible, and the above-described order is only one example.

In the foregoing embodiments, a parking lot 100 to be reserved is on the way to a destination and is used to charge the battery 310. However, a parking lot 100 around the destination may be reserved. In other words, when the customer of a vehicle 300 arrives at a destination, in order to secure the vehicle 300 for return, a parking lot 100 around the destination may be reserved. In this case, if the customer stores his or her luggage in the vehicle 300, it is difficult for the vehicle 300 to agree to mediation. However, when a vehicle other than the vehicle 300 is used for return, the vehicle 300 can easily agree to mediation.

The various functions described in the foregoing embodiments may be implemented in hardware or in a combination of software and hardware. When the functions are implemented in software, they can be stored in or transmitted by a computer readable storage medium as one or more instructions or codes (programs). Such a recording medium has only to be accessed by a computer or a processor, and is not particularly limited. As examples of the recording medium, a RAM, a ROM, an electrically erasable programmable read-only memory (EEPROM) (including a universal serial bus memory and a memory card), an optical disk such as a compact disk (CD) ROM, a magnetic disk such as a hard disk, and the like can be used. It can also be transmitted over a wireless or wired telecommunications line. The same is true for various types of data.

While certain embodiments have been described, these embodiments have been presented by way of example only, and are not intended to limit the scope of the inventions. Indeed, the embodiments described herein may be embodied in a variety of other forms; furthermore, various omissions, substitutions and changes in the form of the embodiment described herein may be made without departing from the spirit of the invention. The accompanying claims and their equivalents are intended to cover such forms or modifications as would fall within the scope and spirit of the inventions.

What is claimed is:

1. An information processing device to reserve a parking lot for a vehicle, comprising:
a reception unit which receives first information regarding a destination of the vehicle;
a first retrieval unit which retrieves a route to the destination based on the first information;
a second retrieval unit which retrieves a route to the destination, a first area around the route, and first time; and
a reservation unit which requests a reservation for a first parking lot in the first area at the first time using wireless or wired communication without waiting for an instruction from a user.

2. The information processing device of claim 1, wherein:
the vehicle is an electric vehicle;
the first parking lot includes a charger which is able to charge a battery of the vehicle;
the information processing device further comprises a first determination unit which determines based on the first information and the retrieved route whether the battery needs to be charged before the vehicle reaches the destination; and
the reservation unit requests the reservation when the first determination unit determines that the battery needs to be charged.

3. The information processing device of one of claim 1, wherein:
the information processing device stores second information regarding priority of a parking lot that is able to be assigned to the vehicle;
upon receiving a notice indicating that the first parking lot corresponding to first priority in the second information is not found by wireless or wired communication,
the first retrieval unit changes the route or the second retrieval unit changes the first area and the first time; and
the reservation unit requests a reservation for a first parking lot that satisfies the changed route or the changed first area and first time by the wireless or wired communication without waiting for an instruction from the user.

4. The information processing device of claim 3, further comprising a third determination unit which, when the third determination unit receives information regarding a second parking lot other than the first parking lot by wireless or wired communication, identifies a vehicle whose operating schedule is changeable in the second parking lot and transmits the vehicle by the wireless or wired communication without waiting for an instruction from the user.

5. An information processing device to manage a parking lot for a vehicle, comprising:
a first retrieval unit which retrieves a first parking lot based on a reservation request for a parking lot, reservation request being transmitted by wireless or wired communication;
a calculation unit which calculates a parking fee of the first parking lot retrieved by the first retrieval unit; and
a reservation unit which assigns a vehicle corresponding to the reservation request to the first parking lot.

6. The information processing device of claim 5, wherein:
the information processing device stores first information regarding a parking fee;
the first information includes a coefficient corresponding to at least one of an available state of the first parking lot, an available state of surrounding parking lots, parking time in the reservation request, and an evaluation of the first parking lot; and
the calculation unit calculates the parking fee using the coefficient.

7. The information processing device of claim 5, wherein:
the first retrieval unit retrieves a plurality of parking lots based on a reservation request for the parking lot;
the calculation unit calculates a parking fee for each of the parking lots; and
the reservation unit selects one of the parking lots as the first parking lot based on the calculated parking fee.

8. The information processing device of claim 5, wherein:
the vehicle is an electric vehicle;
the parking lot includes a charger which is able to charge a battery of the vehicle;
the information processing device stores second information to manage a plurality of parking lots;
the second information includes at least one of a location, a use time, how many vehicles is able to be parked, a basic fee, and charging capability for each of the parking lots;
the reservation request includes at least information regarding a destination of the vehicle; and
the first retrieval unit retrieves a parking lot based on the reservation request and the second information.

9. The information processing device of claim 5, wherein:
the information processing device stores third information regarding priority of a parking lot that is able to be assigned to the vehicle; and
when a second parking lot corresponding to first priority in the third information is not found, the information processing device transmits a request for changing a parking lot retrieval condition by wireless or wired communication.

10. The information processing device of claim 9, wherein:
the vehicle belongs to a first group;
when the second parking lot corresponding to the first priority is not found, the information processing device retrieves a third parking lot which differs from the second parking lot and for which another vehicle belonging to the first group is reserved; and
when the third parking lot is found, the information processing device cancels the reservation for said another vehicle and assigns the third parking lot to the vehicle for which the reservation request is made.

11. The information processing device of claim 5, wherein:
upon receiving an instruction for closing a parking lot managed by the information processing device by wireless or wired communication, the information processing device closes the parking lot;
upon receiving a mediation request by wireless or wired communication, the information processing device calculates a fee necessary to move a vehicle for which the parking lot is reserved; and
the information processing device updates a reservation state of the parking lot.

12. An information processing method for managing a parking lot, comprising:
receiving a reservation request for the parking lot and issuing a reservation acquisition instruction at a desired occupancy time based on the reservation request;
receiving a reservation state of the parking lot;
issuing an instruction for closing an available space when there is the available space at the desired occupancy time as a result of receiving the reservation state;
requesting mediation when there is no available space at the desired occupancy time as a result of receiving the reservation state;
receiving a fee necessary for the mediation when the mediation is performed; and
receiving a confirmation for moving a vehicle for the mediation and issuing an instruction to move the vehicle based on the confirmation.

13. A non-transitory computer readable medium storing an information processing program for managing a parking lot, the program being executed by a processor which is caused to:
receive a reservation request for the parking lot and issue a reservation acquisition instruction at a desired occupancy time based on the reservation request;
receive a reservation state of the parking lot;
issue an instruction for closing an available space when there is the available space at the desired occupancy time as a result of receiving the reservation state;
request mediation when there is no available space at the desired occupancy time as a result of receiving the reservation state;
receive a fee necessary for the mediation when the mediation is performed; and
receive a confirmation for moving a vehicle for the mediation and issue an instruction to move the vehicle based on the confirmation.
